(19) United States
(12) Patent Application Publication
(10) Pub. No.: US 2026/0079912 A1
(43) Pub. Date: Mar. 19, 2026

(54) Updating User Information in a Cloud Platform

(71) Applicant: Salesforce, Inc., San Francisco, CA (US)

(72) Inventors: Joshua Kim ENTZ, Seattle, WA (US); Ajay Kumar Rabidas, Seattle, WA (US); Zoltan SZUGYI, Seattle, WA (US); Mihir Prahalladbhai PATEL, Sammamish, WA (US)

(21) Appl. No.: 19/083,360

(22) Filed: Mar. 18, 2025

Related U.S. Application Data
(60) Provisional application No. 63/694,739, filed on Sep. 13, 2024.

(30) Foreign Application Priority Data
Jan. 30, 2025 (IN) 202541007755

(51) Int. Cl. G06F 16/23; G06F 16/28

(52) U.S. Cl. CPC G06F 16/2365; G06F 16/287

(57) ABSTRACT

A computing device receives a request to modify user information with respect to at least a first site of a plurality of sites. In response to the request to modify the user information, the device executes a workflow to update the user information, including updating a global table with temporary changes corresponding to the user information and initiating an update to a local table with the user information. The local table is stored in a database that is associated with a server instance where the first site is deployed at. In accordance with a determination that the update to the local table failed, the device rollbacks the temporary changes made to the global table; and in accordance with a determination that the update to the local table was successful, the device commits updates made to the global table and the local table and marks the workflow as completed.

### RELATED APPLICATIONS

This application claims priority to Indian Application No. 202541007755, filed Jan. 30, 2025, entitled “UPDATING USER INFORMATION IN A CLOUD PLATFORM”; and U.S. Provisional Patent Application No. 63/694,739, filed Sep. 13, 2024, entitled “USER PROVISIONING ACROSS ANALYTICAL CONTENT BOUNDARIES AND MULTIPLE REGIONS,” each of which is incorporated by reference in its entirety.

### TECHNICAL FIELD

The disclosed embodiments relate generally to user management and more specifically to systems, methods, and graphical user interfaces for managing users of systems and services deployed on a cloud infrastructure.

### BACKGROUND

A data visualization application, such as Tableau, can be offered to customers as an on-premise deployment on a server to allow organizations to host and manage data within their own infrastructure. Alternatively, a data visualization platform can be hosted as a software as a service (SaaS) solution on a cloud platform to allow organization an ability to access and analyze data through a web browser without needing on-premises infrastructure (e.g., without the need for owning and managing a data center and a server to host the data visualization platform).

### SUMMARY

Multi-tenancy is a means of providing a single application (or a software platform with multiple applications, features, functions, and services, such as Tableau) to multiple organizations, such as different companies or different departments within a single company, from a single hardware-software stack. A tenant in a cloud is a top-level administrative layer that encompasses an organization's cloud deployment, such as Tableau Cloud deployment. For example, a tenant is a container that holds all sites, users, and licenses that are associated with a respective organization. A cloud administrator operates at the level of a tenant through a cloud manager, ensuring centralized control over the cloud. Within this structure, a cloud manager acts as a centralized location to configure changes for multiple sites, such as adding or deleting users and license management. Further, multiple sites can be managed under a single tenant. For example, a site, by comparison, is under the tenant and can be thought of as a workspace or a dedicated environment for a specific team, department, or project. Each site has its own set of content, users, and permissions, which site administrators manage. While site administrators have control over their individual sites, including managing workbooks, data sources, and user access, they operate within the constraints set at the tenant level. Sites provide a focused area for collaboration and analytics without exposing the administrative functions of the tenant. There is a need for single centralized system for managing users across multiple sites under one tenant. In some embodiments, a cloud management service includes a global user identity service that allows adding and deleting users across multiple sites and/or different geographic regions. The orchestration of such global user identity service poses challenges with respect to synchronization of a global logical database updated by cloud administrators via user interfaces of the cloud manager and local databases deployed on local servers optionally in different geographic regions.

The global identity service of the cloud manager functions as a centralized user management interface to streamline the process of managing cloud users (e.g., individuals such as employees, group members, licensees, etc.) and cloud sites. In particular, the cloud manager facilitates synchronization between global and local databases (e.g., tables that store user information including data and metadata), ensuring that user information remains consistent and up to date over the cloud. Moreover, unlike traditional systems, which may limit cloud user management to a specific geographic region, the cloud manager enables a cross-region and/or cross-site user identity management (e.g., the same users may be added or deleted from one or more cloud sites that optionally are deployed at different geographic regions). This configuration eliminates the need to manage separate cloud user pools or create duplicate user information (e.g., user identities, user memberships, user licensing, etc.) for different regions, thereby significantly reducing administrative overhead, providing flexibility in user management, and promoting a unified and centralized framework.

Furthermore, with the cloud manager, the management of user licensing is no longer restricted to a per server or per cloud site basis. Instead, the cloud manager supports a more flexible and centralized licensing system, enabling customers to allocate and manage licenses dynamically across cloud sites in various regions. This not only simplifies the processing of allocating licenses but also ensures better resource utilization and scalability in a cloud infrastructure setting (e.g., computation resources, storage resources, etc.) particularly for organizations with a distributed cloud infrastructure. In particular, the cloud manager provides an efficient solution for managing cloud environments across regions and on a global scale.

In some embodiments, a method includes receiving a request to modify user information with respect to at least a first site of a plurality of sites. In response to the request to modify the user information, a first workflow to update the user information is executed. Execution of the workflow includes updating a global table with temporary changes corresponding to the user information; and initiating an update to a local table with the user information. The local table is stored in a database that is associated with a server instance where the first site is deployed at. The method further includes, in accordance with a determination that the update to the local table failed, a rollback of the temporary changes made to the global table is performed; and in accordance with a determination that the update to the local table was successful, updates made to the global table and the local table with respect to the user information are committed and the first workflow is marked as completed.

In accordance with some embodiments, execution status of the first workflow is tracked in a central database. The method includes in accordance with a determination that the update to the global table was successful and the update to the local table was successful, marking the first workflow as completed in the central database.

In some embodiments, the method further includes, in accordance with a determination that the request to modify the user information is initiated from a first region and that the first site is deployed at a second region different from the first region, invoking a user replication service deployed at the first region to initiate execution of the first workflow.

In some embodiments, the method includes, in accordance with a determination that the request to modify the user information is initiated from a first region and that the first site is deployed at a second region different from the first region, invoking, by a user replication service deployed at the first region, a user replication service deployed at the second region to initiate execution of the first workflow.

In some embodiments, the request to modify the user information is received from a first user interface of a global cloud manager system. The request to modify the user information and the first workflow are executed asynchronously. The first user interface sends polling requests to the central database to determine whether the first workflow has been successfully completed.

In some embodiments, the request to modify the user information is received from a second user interface of a data visualization system deployed at the server instance. The request to modify the user information and the first workflow are executed synchronously, such that the second user interface forgoes polling requests to a central database to determine whether the first workflow has been successfully completed.

In some embodiments, the request to update the user information is associated with a respective user record. The method further includes, in response to the request to modify the user information, in accordance with a determination that a second workflow that is associated with the respective user record is active, aborting the first workflow; and in accordance with a determination that there is no other active workflow associated with the respective user record, marking the first workflow to update the user information active in a central database.

In accordance with some embodiments, a computing device includes one or more processors, memory, and one or more programs stored in the memory. The programs are configured for execution by the one or more processors. The one or more programs include instructions for performing any of the methods described herein. In some embodiments, the computing device (e.g., a computer) is optionally in communication with one or more displays.

In accordance with some embodiments, a non-transitory computer-readable storage medium stores one or more programs configured for execution by a computing device having one or more processors and memory. The one or more programs include instructions for performing any of the methods described herein.

Thus methods, systems, and graphical user interfaces are disclosed that enable users to easily manage cloud users of systems and services in a region and cross regions (e.g., in-region cloud user management and cross-region cloud user management).

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description below, in conjunction with the following drawings in which like reference numerals refer to corresponding parts throughout the figures.

FIG. 1A illustrates a cloud management system, in accordance with some embodiments.

FIG. 1B illustrates an example cloud platform distributed across different geographic regions, in accordance with some embodiments.

FIG. 2 illustrates a cloud management system, in accordance with some embodiments.

FIG. 3 (e.g., FIGS. 3A and 3B) illustrates an example in-region process for synchronizing user information corresponding to an in-region cloud user update, in accordance with some embodiments.

FIG. 4 (e.g., FIGS. 4A and 4B) illustrates another example in-region process for synchronizing user information corresponding to an in-region cloud user information update, in accordance with some embodiments.

FIG. 5 (e.g., FIGS. 5A and 5B) illustrates an example cross-region process for synchronizing user information corresponding to a cross-region cloud user information update, in accordance with some embodiments.

FIG. 6 (e.g., FIGS. 6A and 6B) illustrates another example cross-region process for synchronizing user information corresponding to a cross-region cloud user information update, in accordance with some embodiments.

FIGS. 7A-7D illustrate example graphical user interfaces of a cloud management system for updating user information, in accordance with some embodiments.

FIGS. 8A-8C illustrate another example graphical user interfaces of a cloud management system for updating user information, in accordance with some embodiments.

FIG. 9 is a block diagram illustrating a computing device, in accordance with some embodiments.

FIGS. 10A-10C illustrate a flow chart of an example method for managing user information, in accordance with some embodiments.

### DETAILED DESCRIPTION

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

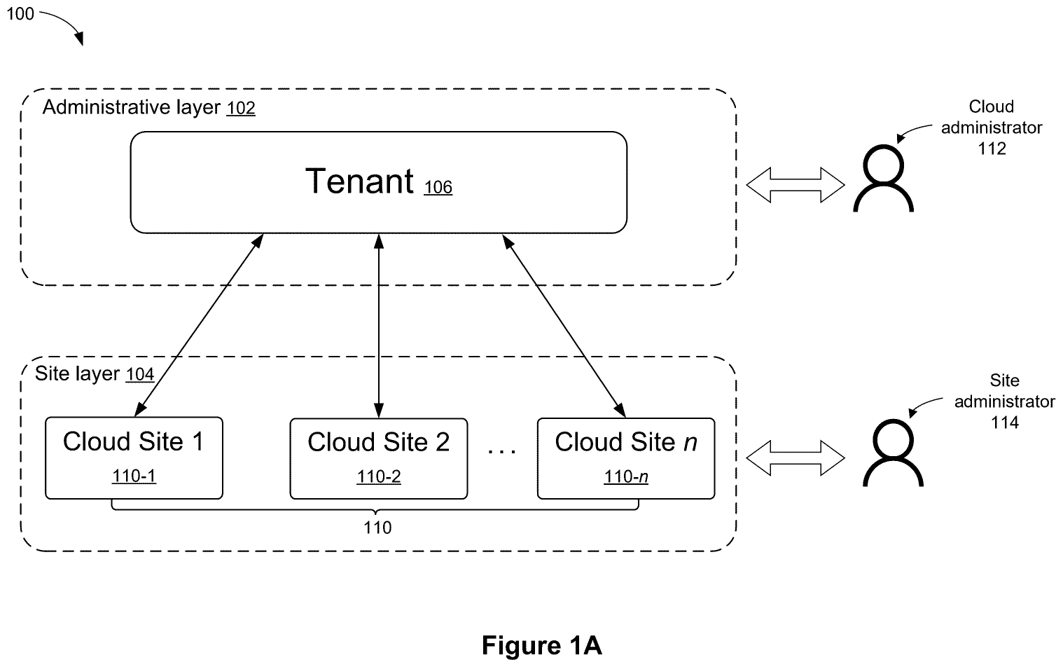

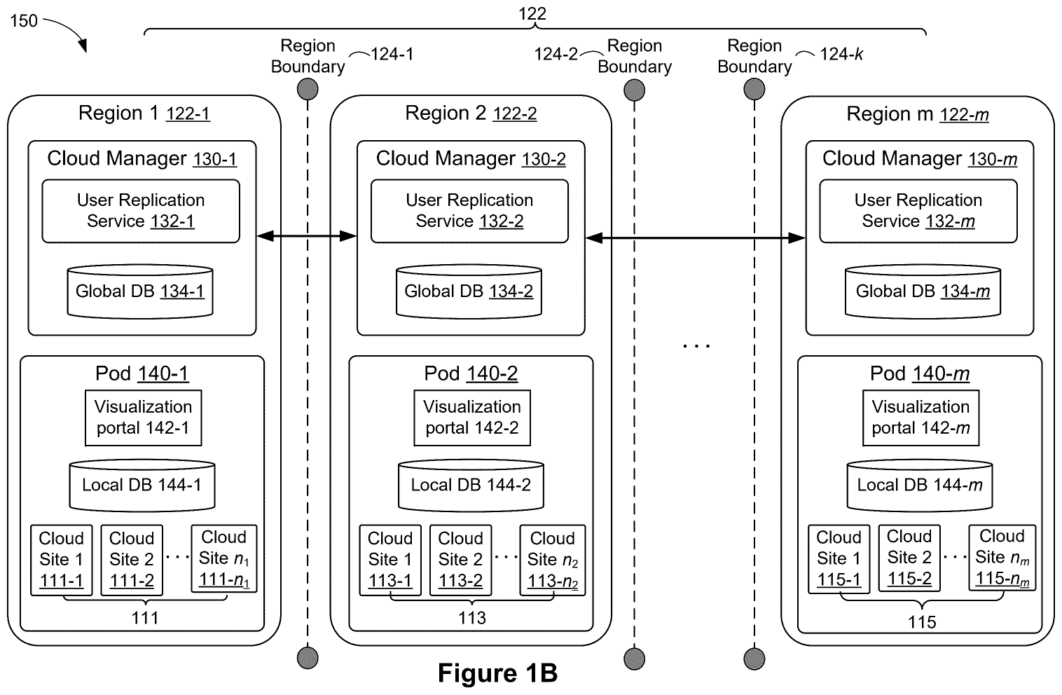

FIG. 1A illustrates a cloud management system 100, in accordance with some embodiments. The cloud management system 100 is used for administering and managing tenants and sites in a cloud environment. The cloud management system 100 includes a centralized management interface for cloud administrators to provision and configure cloud sites, users and respective roles and access privileges, and/or other settings. A cloud administrator creates and configures cloud sites, manages site users, and monitors license consumption across cloud sites. In some embodiments, the example cloud management system 100 is deployed at different regions (e.g., cloud managers 130-1, 130-2, and 130-3 in FIG. 1B are deployed at regions 122-1, 122-2, and 122-m, respectively).

In some embodiments, the cloud management system 100 includes an administrative layer 102 and a site layer 104. The administrative layer 102 functions at a centralized level for overseeing system-wide configurations, user licenses, and user accesses. The site layer 104 operates at a localized level for managing individual sites. This architecture allows for a centralized control at the administrative layer 102 and a flexible management at the site layer 104, enabling customers to control and operate centrally multiple sites. In some embodiments, the administrative layer 102 includes a tenant 106, and the site layer 104 includes a plurality of cloud sites 110 (e.g., cloud site 1 110-1 to cloud site n 110-n, where n is an integer greater than one). Typically, a customer (e.g., an organization, an entity, etc.) is assigned to a tenant and a tenant is associated with multiple sites. Table 1 below illustrates an example tenant and site hierarchy:

```
TABLE 1
[
{
“tenants”: [
  {
    “name”: “tenant-456”,
    “state”: “Active”,
    “uri”: “tenant456”,
    “id”: “72749716-91b3-4828-ac7b-3cc478c84299”,
    “instanceDomain”: “<link to tenant session service podagnostic
    endpoint>”,
“sites”: [
  {
    “name”: “site-123”,
    “state”: “Active”,
    “uri”: “site123”,
    “instanceDomain”: “https://prod-apnortheasta.online.tableau.com”,
    “id”: “918fe190-492a-11ed-acc2-0a61dcca52fb”
},
{
    “name”: “site-456”,
    “state”: “Active”,
    “uri”: “site456”,
    “instanceDomain”: “https://prod-caa.
    online.tableau.com”,
    “id”: “018fe190-492a-11ed-acc2-0a61dcca52fa”
    }
  ]
}
],
“username”: “ABC@TABLEAU.COM”
}
]
```

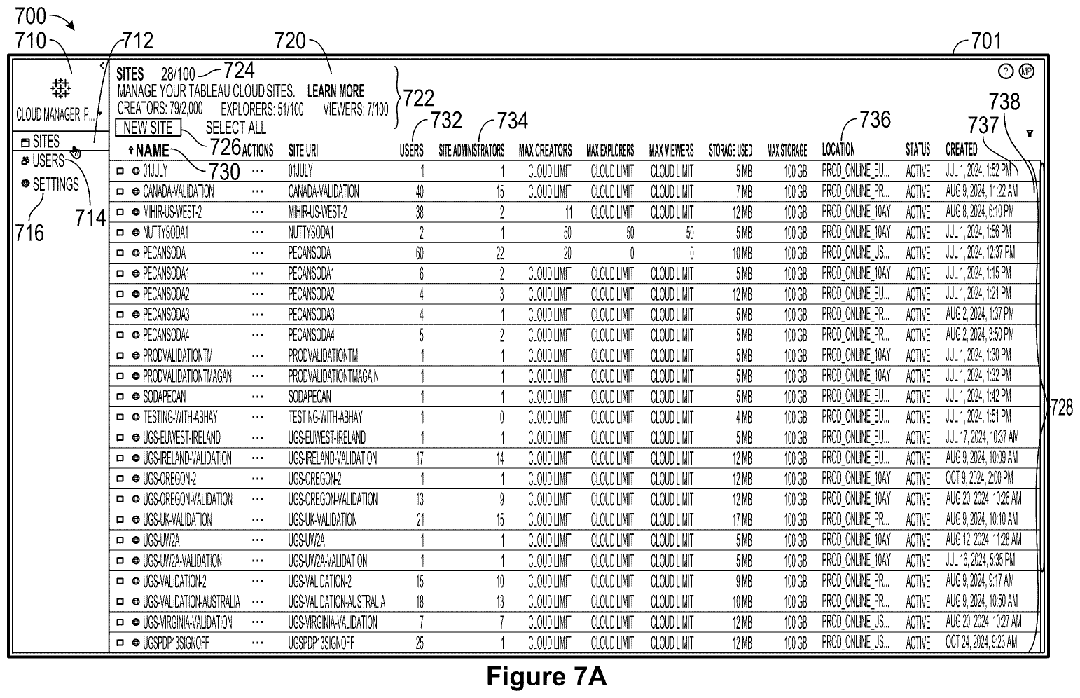

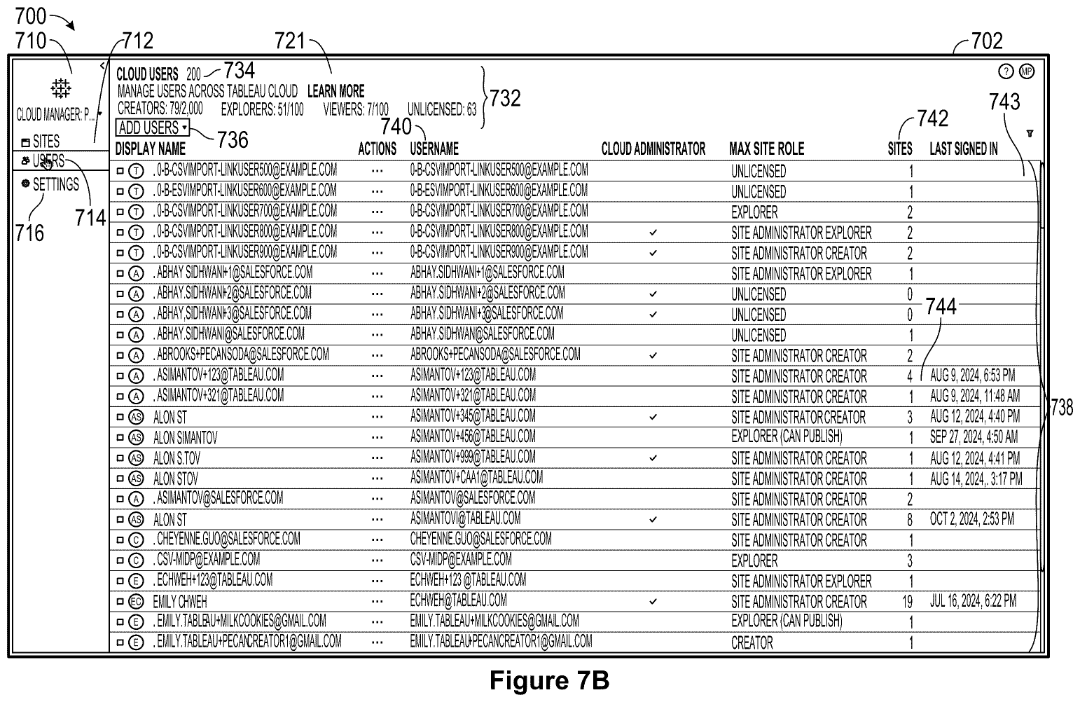

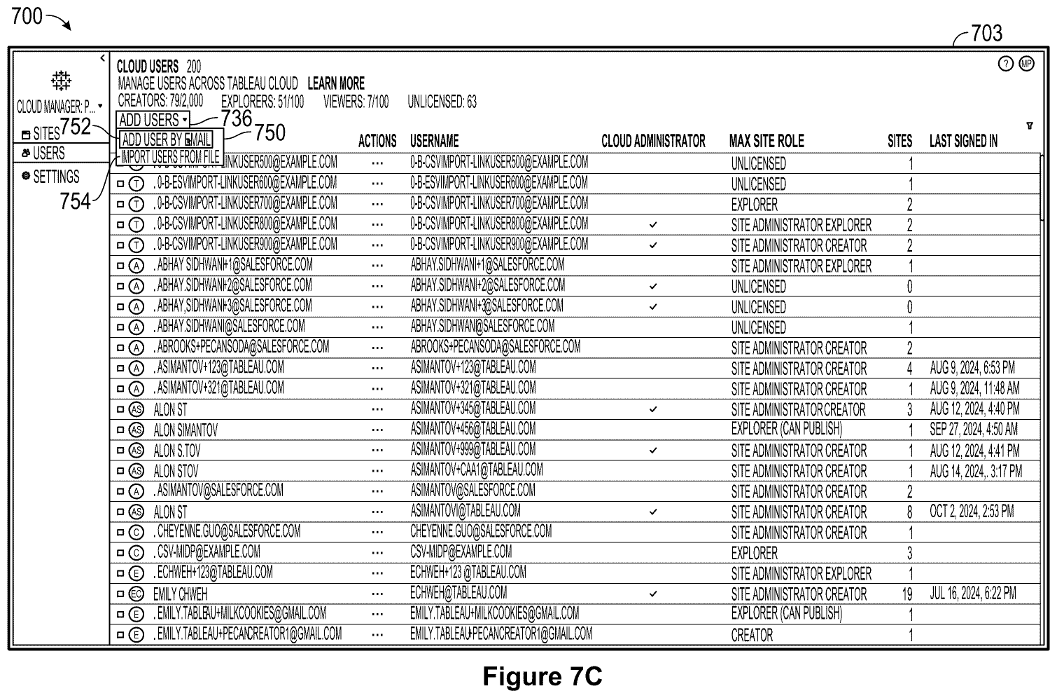

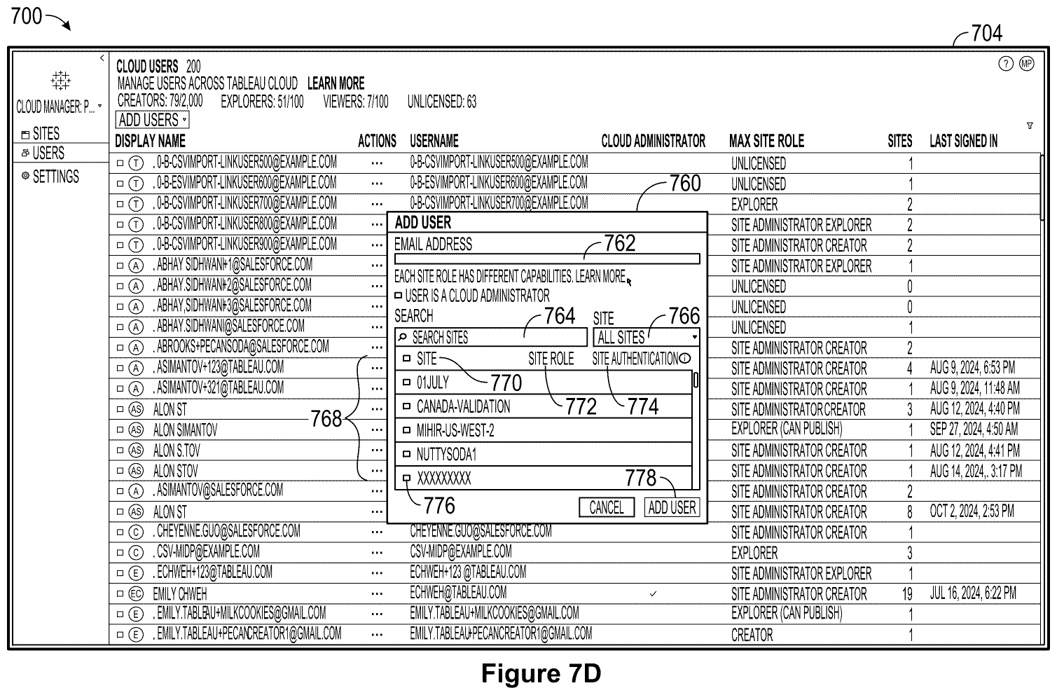

In some embodiments, the tenant 106 is managed by a cloud administrator 112. In some embodiments, the tenant 106 serves as a container that encompasses associated sites, users, and licenses. In some embodiments, the cloud administrator 112 manages the tenant 106's multiple sites and users centrally through a user interface (e.g., example graphical user interfaces 700 of the cloud management system 100 in FIGS. 7A-7D) of a cloud management system 100. In some embodiments, the cloud administrator 112 manages configurations across the plurality of cloud sites 110 associated with tenant 106, including user provisioning and deprovisioning (e.g., adding and deleting users) and license management. In some embodiments, the cloud administrator 112 is the only user with access to the tenant 106 of the administrative layer 102 of the cloud management system 100. This is a role assigned explicitly to the administrative layer 102. In some embodiments, the administrative layer 102 includes one or more tenants, and the cloud administrator 112 and each tenant is managed by a respective group of one or more cloud administrators.

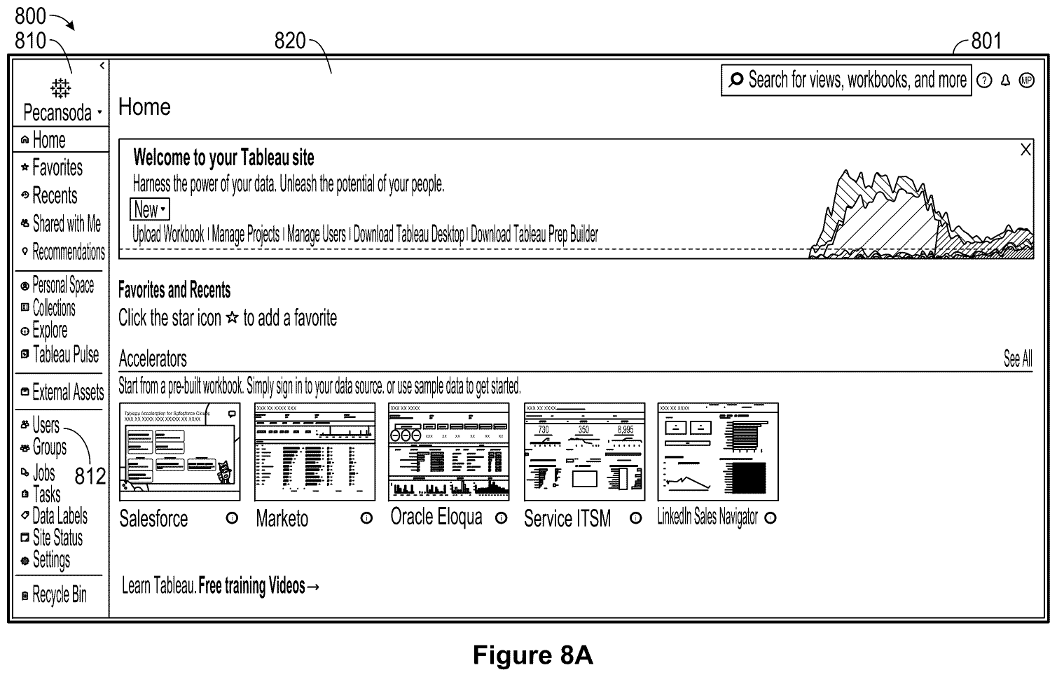

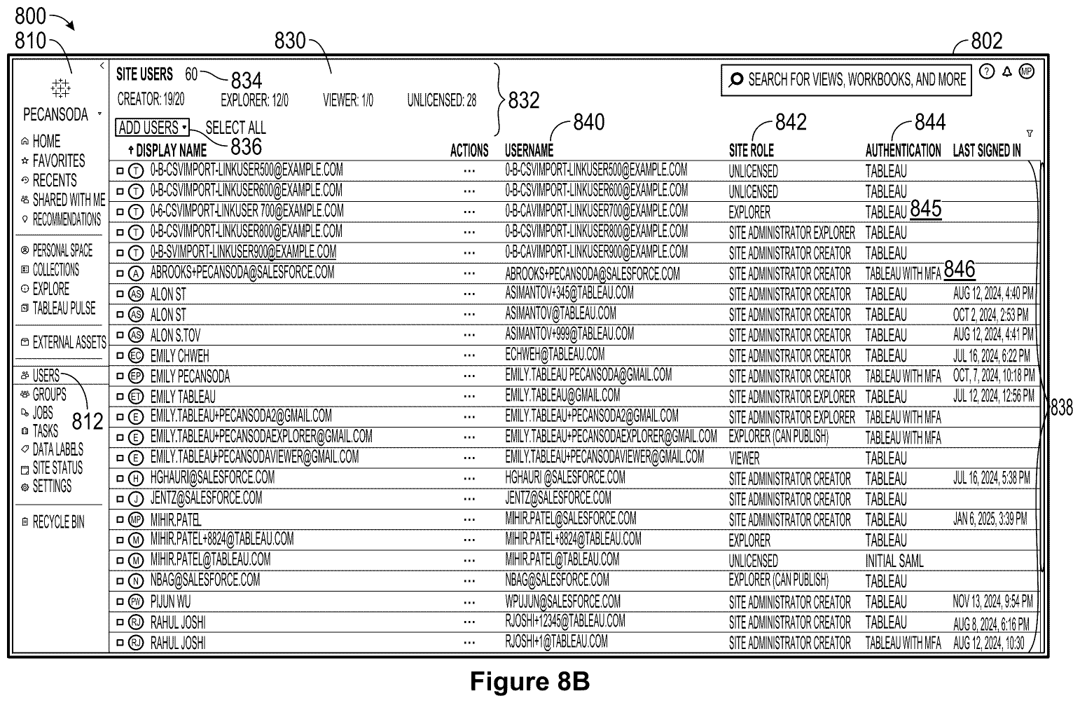

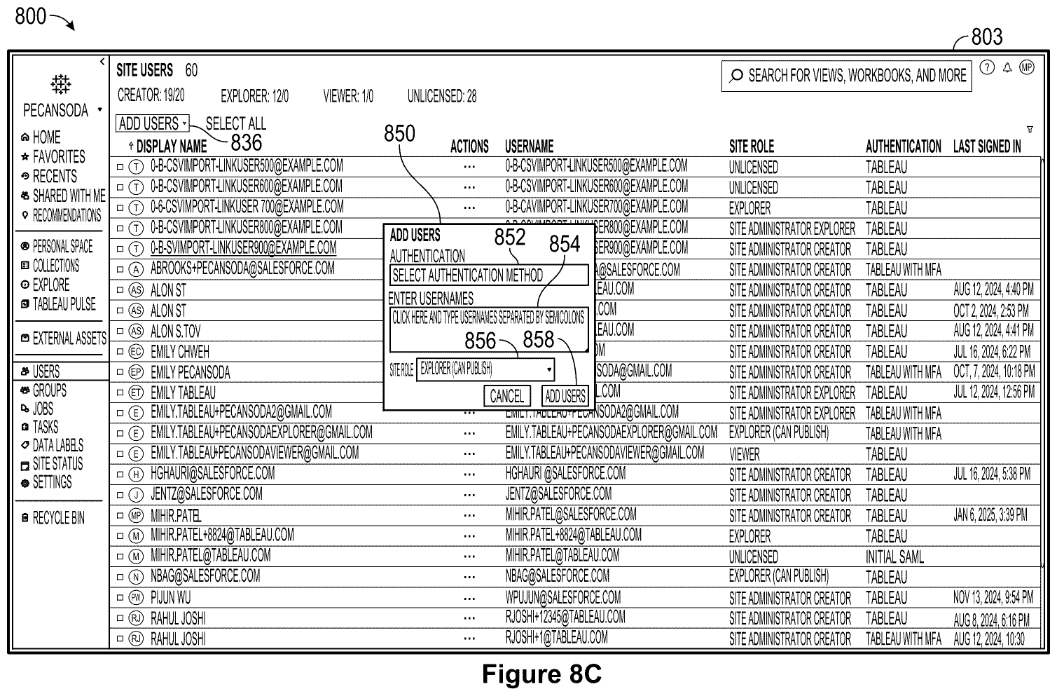

In some embodiments, each respective site of the plurality of cloud sites 110 are managed by corresponding site administrators, such as site administrator 114. In some embodiment, the site administrator 114 manages one or more site of the plurality of cloud sites 110 through a user interface (e.g., example graphical user interfaces 800 of the cloud management system 100 in FIGS. 8A-7C) of the cloud management system 100. In some embodiments, the plurality of cloud sites 110 operate as subordinate entities (e.g., workspace(s), work environment(s) dedicated for a specific team, department, or project) under the tenant 106 and work independently. Each site of the plurality of cloud sites 110 includes its own set of contents (e.g., users and user groups, respective access privileges, user licenses, workbooks, data sources, connections, dashboards, data visualizations, etc.). In some embodiments, the plurality of cloud sites 110 operate within configurations, licenses, policies and constraints defined set at the administrative layer 102. For example, a respective site of the plurality of cloud sites 110 is isolated from and not exposed to other sites of the plurality of cloud sites 110. In some embodiments, the site administrator 114 includes a group of site administrators and each of the group of site administrators manages a corresponding cloud site or a corresponding subset of the plurality of cloud sites 110.

In some embodiments, a change made within the cloud management system 100 is optionally applied across all cloud sites (e.g., the plurality of cloud sites 110) associated with the tenant 106 for ensuring a streamlined administration and governance. In some embodiments, multiple cloud sites (e.g., the plurality of cloud sites 110) are deployed on a same hardware infrastructure located at one region (e.g., local servers hosted in a datacenter in a geographic region). In some embodiments, multiple cloud sites associated with the same tenant may be distributed across different geographic regions (e.g., the plurality of cloud sites 110 are deployed at different regions. For example, local servers are hosted in distinct datacenters in different geographic regions). In another example, several cloud sites may be located at different geographic regions for regional compliance and policies.

FIG. 1B illustrates an example cloud platform 150 distributed across different geographic regions, in accordance with some embodiments. In some embodiments, the cloud platform 150 includes replicas of the cloud management system 100 (e.g., cloud manager 130-1 to cloud manager 130-m, where m is an integer greater than one) and data visualization software (e.g., a plurality of pods 140-1 to 140-m, where m is an integer greater than one) installed and optionally running on hardware infrastructure located at different regions. For example, the cloud management system 100 manages cloud users across a plurality of regions 122 (e.g., region 1 122-1 to region m 122-m, where m is an integer greater than one), where the separation in plurality of regions 122 is illustrated by region boundaries (e.g., region boundary 124-1 to region boundary 124-k, where k is an integer greater than one). In some embodiments, the cloud users includes customers (e.g., organizations, entities, etc.), cloud administrators (e.g., cloud administrator 112), and site administrators (e.g., site administrator 114). In some embodiments, each of the plurality of regions 122 includes a geographic area where data centers are deployed by a cloud service provider. The plurality of regions 122 are designed to allow the cloud users to choose locations for hosting their data and resources, thereby improving performance, meeting regulatory requirements, and/or improving scalability. In some embodiments, the region boundaries 124-1, 124-2, and 124-m includes a geographical and operational limit that defines the scope within which the infrastructure, services, and data are managed and operated in the context of technical, legal, and/or performance implications.

In some embodiments, multiple instances of the cloud management system 100, such as cloud manager 130-1, cloud manager 130-2, and cloud manager 130-m are installed and running on a respective hardware infrastructure located at different regions 122-1, 122-2, and 122-m, respectively. In some embodiments, the plurality of pods 140-1 to 140-m include data visualization and analytics software stack and are also installed on respective hardware infrastructure located at different regions 122-1 to 122-m, as illustrated in FIG. 1B. In some embodiments, each pod of the plurality of pods 140-1 to 140-m includes one or more pods corresponding to different data visualizations and analytics software stacks (e.g., more than one pods can be deployed within a single region).

In some embodiments, the cloud manager system 100 and respective instances or deployments (e.g. cloud manager 130-1, cloud manager 130-2, and cloud manager 130-m) include a number of services including, but not limited to, user service for managing users (e.g., adding, deleting, modifying user information), tenant service for managing tenants (e.g., adding, deleting, or otherwise modifying tenant information), orchestration service, gateway service, session service, entitlement service, and/or other cloud services. For example, the cloud manager 130-1, cloud manager 130-2, and cloud manager 130-m each includes a user replication service (e.g., user replication service 132-1, user replication service 132-1, user replication service 132-m) that synchronizes user information between a global database (e.g., global database 134-1, global database 134-2, and global database 134-m) accessed by the cloud management system 100 and local databases (e.g., local database 144-1, local database 144-2, and local database 140-m) accessed by respective pods (e.g., pod 140-1, pod 140-2 and pod 140-m). In some embodiments, the cloud management system 100 has access to read from and write into replicas of the global database that are also installed on the respective hardware infrastructure located at different regions 122-1 to 122-m, as illustrated in FIG. 1B. For example, replicas 134-1, 134-2, and 134-m of the global database are installed on respective hardware infrastructure located at different regions 122-1, 122-2, and 122-m. In some embodiments, a cloud manager acts as a layer atop customer's cloud sites (e.g., Tableau cloud sites), providing centralized management features. Customers that deploy multiple sites can manage sites and licenses of users in one place, including granting users access to multiple sites without requiring distinct licenses for each site. Further, a cloud manager also introduces a cloud administrator user role, a level above a traditional site administrator user role. This allows for more flexibility and allows an organization to manage data visualization and analytics platform according to specific needs. For example, a smaller organization may assign the same user a cloud administrator and also a site administrator role. In another example, for larger organizations, a cloud administrator could be someone in IT using higher-level administrative capabilities to implement more control and coordination across customer's multiple cloud sites. In some embodiments, the local database (e.g., local database 144-1, local database 144-2, and local database 140-m) includes a Postgre database.

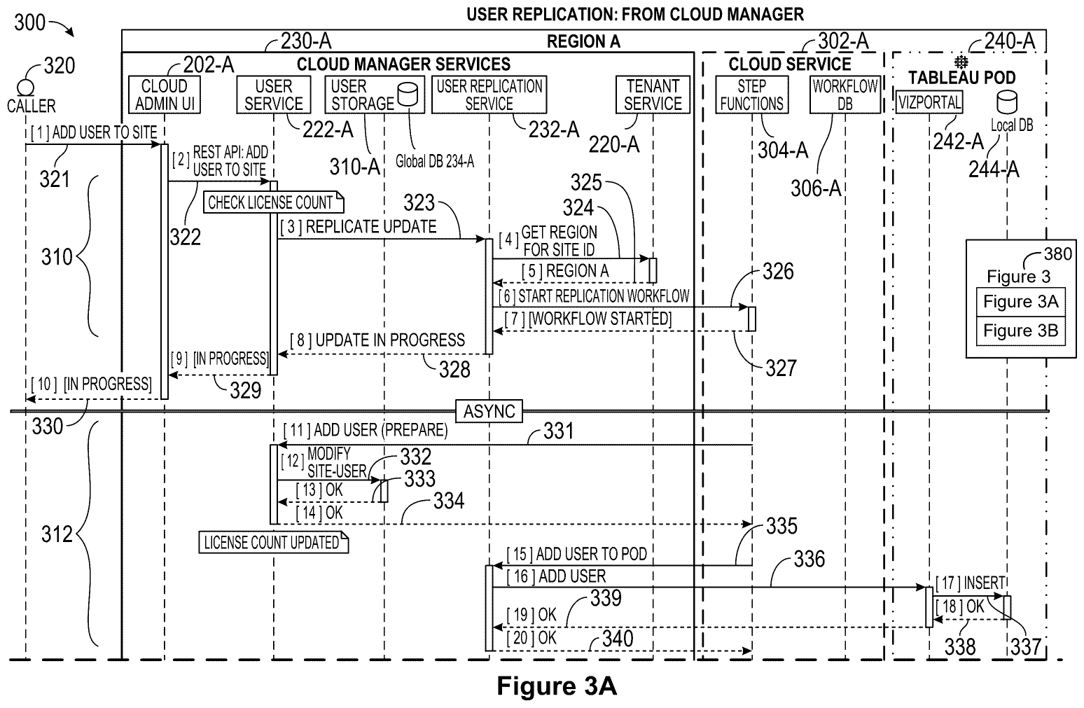

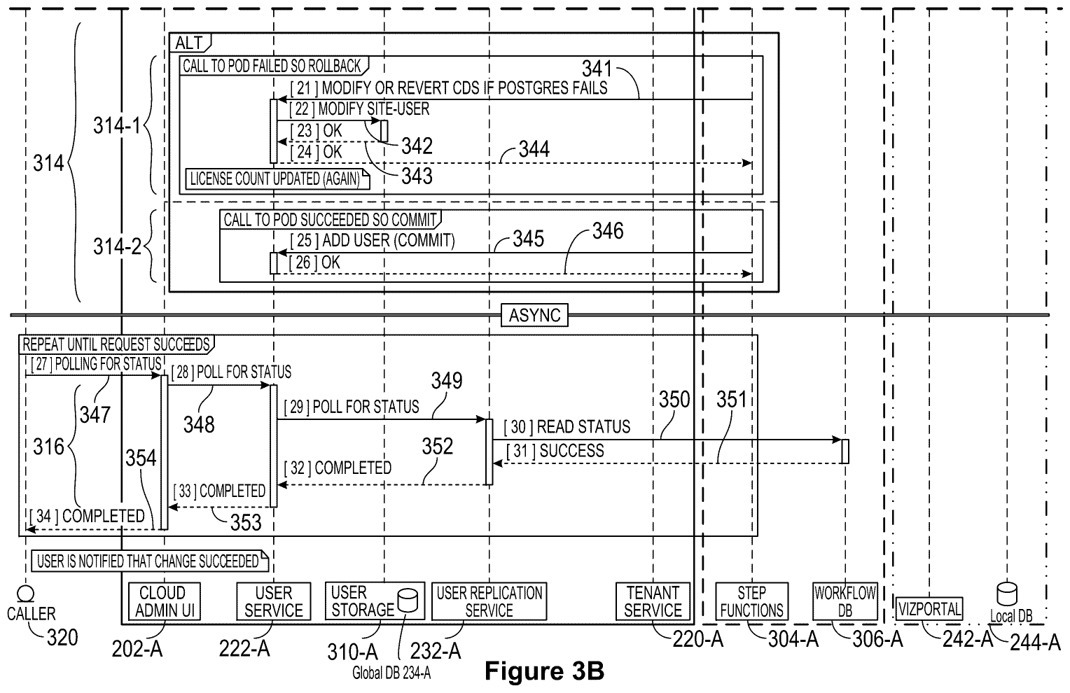

In some embodiments, a pod refers to a dedicated instance or section within a cloud platform (e.g., cloud platform 150) where a user's data, sites, and services reside, thereby acting as a separate environment within a larger infrastructure. For example, Tableau cloud sites, services, and data reside on pods. Pods are often used to manage data locality and security based on region or specific needs. Customer can migrate their cloud sites to different pods residing in different regions (e.g., migrate a site from the U.S. to Europe to comply with data privacy and security law). Pods are used to group resources within a cloud platform. In some embodiments, pods can be scaled independently to meet the demands of different user groups. In some embodiments, users can choose a pod located geographically close to them for improved performance. For example, having pods in multiple locations allows faster load times with live connections and speedier extract refreshes. In some embodiments, permissions and access controls can be managed at the pod level. Each pod of plurality of pods 140-1 to 140-m represent a server instance running on hardware infrastructure located at different regions 122-1 to 122-m, respectively, as illustrated in FIG. 1B. Each pod of the plurality of pods 140-1 to 140-m includes a visualization portal (e.g., visualization portal 142-1), a local database 144 (e.g., local database 144-1), and optionally other services and features available on the data visualization and analytics platform. Each pod of the plurality of pods 140-1 to 140-m further includes a plurality of cloud sites (e.g., cloud sites 111 for the pod 140-1, cloud sites 113 for the pod 140-2, cloud sites 115 for the pod 140-m). In some embodiments, the cloud management system 100 is replicated and deployed on hardware infrastructure in each of the plurality of regions 122. For example, the cloud manager 130-1 associated with the “Region 1” 122-1 is a replication of the cloud management system 100 and cloud manager 130-2 associated with the “Region 2” 122-2 is a replication of the cloud management system 100. In some embodiments, a pod (e.g., pod 140-1) includes a server that is a distinct instance within infrastructure of the cloud management system 100 where a cloud site resides. In some embodiments, more than one pod can be deployed within a single region. In some embodiments, a number of the plurality of cloud sites 110 can be scaled to hundreds or thousands. In some embodiments, the replicas 134-1, 134-2, and 134-m of the global database are automatically synchronized with the global database and the local database of the cloud platform 150. In some embodiments, user information is automatically synchronized between respective local database and the replicas of the global database, as described in further detail below with respect to FIGS. 3A-6B and FIG. 9.

In some embodiments, the visualization portal (e.g., visualization portal 142-1) of a pod (e.g., pod 140-1) is a customized web interface that allows users to access data visualization platform and applications in a centralized location. For example, users can access data visualizations, dashboards and other content from a single portal, simplifying navigation and data exploration. Optionally, organizations can tailor the portal to match their branding and user needs, including specific dashboards and data views. Further, data visualizations can be embedded directly into the portal, providing a seamless user experience. In some embodiments, the local database (e.g., local database 144-1) stores user data associated with cloud sites deployed locally in the same region. For example, the local database 144-1 of the pod 140-1 deployed at the “Region 1” 122-1 stores user data associated with the cloud sites 110-1 to 110-n₁, and the local database 144-m of the pod 140-m deployed at the “Region m” 122-m stores user data associated with the cloud sites 110-1 to 110-nₘ.

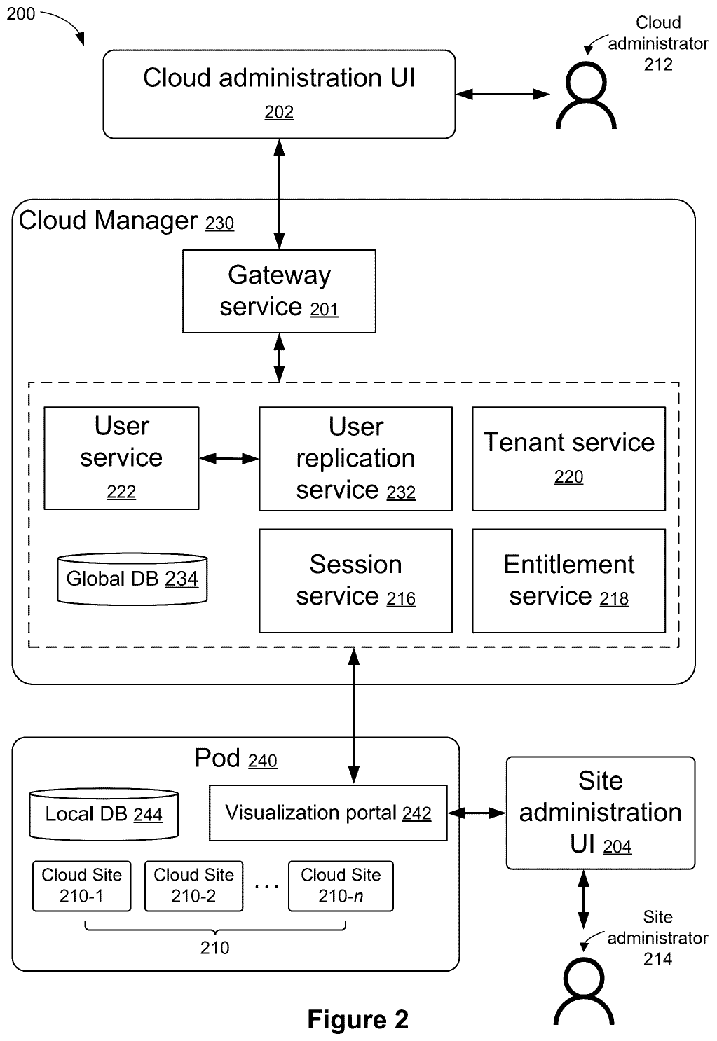

FIG. 2 illustrates a cloud management system 200, in accordance with some embodiments. The cloud management system 200 includes a cloud administrator 212 and a site administrator 214 who manage cloud users. In some embodiments, the cloud management system 200 corresponds to the cloud platform 150 and includes the same or similar functionality as the cloud platform 150. For example, the cloud management system 200 includes a cloud manager 230 (e.g., similar to cloud managers 130-1 to 130-m in FIG. 1B), a pod 240 (e.g., similar to pods 140-1 to 140-m in FIG. 1B), a cloud administration user interface 202 (e.g., illustrated in FIGS. 7A-7D), and a site administration user interface 204 (e.g., illustrated in FIGS. 8A-8C). In some embodiments, the cloud manager 130 is configured as an abstraction layer for driving step functions of a cloud service (e.g., more details in reference to FIGS. 3-6). Further, the cloud manager 230 is configured a centralized management interface to manage cloud users across different cloud sites and/or different regions (e.g., adding/removing users to a local cloud sites, changing user accesses, granting user licenses). In some embodiments, the cloud administration user interface 202 provides visual interactive means for the cloud administrator 112 to perform operations such as adding/removing users to and from cloud site, creating organizational structures, and establishing permissions across cloud sites. In some embodiments, the site administration user interface 204 provides visual interactive means for the site administrator 214 to perform operations such as adding/removing users to a specific cloud site, creating projects, and establishing permissions within a specific cloud site.

In some embodiments, the cloud administrator 212 manages cloud users for a plurality of cloud sites 210 available on the pod 140 via the cloud administration user interface 202. For example, the cloud administrator 212 sends a user request to modify user information that is optionally associated with one or more site (e.g., one or more sites of the plurality of cloud sites 210). In some embodiments, the cloud administrator 212 sends a user request to cloud manager 230 to modify user information with respect to a site of the plurality of cloud sites 210 (e.g., adding a new cloud user to one or more sites of the plurality of cloud sites 210). The cloud manager 230 receives the user request to modify the user information and, in response to the user request, initiates a workflow to update the user information (e.g., replicating user data based the user request, as described in further detail with reference to FIGS. 3A-6B). In some embodiments, the cloud manager 130 receives the user request from the cloud administration user interface 202 and gateway service 201. In response to receiving the user request, the cloud manager 230 redirects the user request from the gateway service 201 to another appropriate service, such as user service 222. The user service 222 optionally invokes user replication service 232 that synchronizes the user information between global database 234 and local database 244. For example, when a new cloud user who previously did not exist in the global database 234 is added to a site of the plurality of cloud sites 210, the cloud user needs to be added to the local database 244 and also to the global database 234 to ensure that the user data is consistent across the entire cloud platform (e.g., cloud platform 150). In some embodiments, the cloud administrator 212 can add, delete, or otherwise modify user information with respect to more than one cloud sites that optionally reside in the same region (e.g., the plurality of cloud sites 210 in FIG. 2 reside in the same region where pod 240 is deployed). In some embodiments, user information is replicated in-region when the local database 244 and the global database 234 are deployed to hardware infrastructure in the same region. For example, when the cloud manager 230 and the pod 240 are deployed at the same region (e.g., “Region 1” 122-1 in FIG. 1B), the replication process of user information is an in-region user information update. In some embodiments, user information is replicated cross-region when the local database and the global database are deployed to hardware infrastructure in different geographic regions. Specifically, when the cloud manager and the pod are deployed at different regions (e.g., cloud manger 130-1 deployed at the “Region 1” 122-1 and the pod 140-2 deployed at the “Region 2” 122-2), the replication process is a cross-region user update. In some embodiments, the local database 244 includes a Postgre database.

In some embodiments, a user request (e.g., a user message, a user query) includes user information updates, such as adding a cloud user to a cloud site, remove a cloud user from a cloud site, and modify a cloud user's role for a cloud site. In some embodiments, multiple user information updates are performed based on one or more asynchronous user requests. In some embodiments, the cloud manager 230 includes gateway service 201, user service 222, user replication service 232, tenant service 220, session service 216, and entitlement service 218. In some embodiments, the gateway service 201 is configured to execute a gateway process in a cluster setup (e.g., a cluster of servers) for handling user requests to servers from cloud users. In some circumstances, a single gateway process can run on each node (e.g., server) in a cluster setup. In some embodiments, the user service 222 receives user requests through the gateway service 201 from the cloud administration user interface 202 and/or APIs. In some embodiments, the user service 222 is configured to access the global database 234 that includes global tables (e.g., user identity table(s), user membership table(s)). In some embodiments, the tenant service 220 is configured to manage cloud deployment for cloud sites (e.g., cloud sites 110 of pod 140). In some embodiments, the session service 216 is configured to manage cloud user sessions on servers, monitor cloud user activities within platforms, and enforce access control by managing permissions for data and visualizations, thereby ensuring that concurrent multi-cloud user interactions are seamless and conflict-free. In some embodiments, the entitlement service 218 is configured to manage cloud user permissions and authorizations (e.g., license permissions) for resources and ensure that cloud users only access data, applications, and services they are authorized to (e.g., corresponding to predefined policies, roles, restrictions).

In some embodiments, the user replication service 232 is a service that replicates and synchronizes user information (e.g., user details, roles, access rights, privileges, etc.) between the local database 244 and the global database 234. In some embodiments, the user replication service 232 of the cloud manager 230 is configured as an abstraction layer for driving step functions of a cloud service (e.g., more details in reference to FIGS. 3-6). A main functionality of the user replication service 232 is to start and stop a workflow of replicating user data (e.g., user identities, user accesses, user licenses) and obtain status of the workflow. In some embodiments, the user replication service 132 is configured to drive step functions of a workflow of replicating user data and obtain status of the workflow. In some embodiments, the user replication service 232 of the cloud manager 230 deployed at one region (e.g., “Region 1” 122-1) acts as a proxy of the user replication service 232 of the cloud manager 230 deployed at another region (e.g., “Region 2” 122-2). Specifically, when a call (e.g., a user request) is initiated to update user information across regions, the user replication service 232 deployed at one region (e.g., “Region 1” 122-1) replicates the user request into the user replication service 132 deployed at a target region (e.g., “Region 2” 122-2). In some embodiments, the user replication service 232 of the cloud manager 230 act as a proxy for calls from a workflow into a pod (e.g., pod 240).

In some embodiments, the global database 234 of the cloud manager 230 stores user data associated with cloud users. Specifically, in some embodiments, the global database 234 includes global tables (e.g., user identity table(s), user membership table(s)). For example, the global tables include relational tables and/or a binary large object (BLOB) based on JavaScript Object Notation (JSON). In some embodiments, the cloud manager 230 includes a user storage (e.g., illustrated in FIGS. 3A-6B). In some embodiments, the global database 234 is part of the user storage of the cloud manager 230.

In some embodiments, a cloud management system (e.g., cloud management systems 100 and 200) and/or a cloud platform (e.g., cloud platform 150) includes step functions of a cloud service (not shown in FIG. 2) communicatively coupled to the cloud manager 230. In particular, the step functions of the cloud service act as a central orchestrator. In some circumstances, the step functions of the cloud service are configured to (i) initiate an API call to the user service 222 of the cloud manager 230 to perform an operation, (2) initiate an API call to the pod 240 to perform an operation, (3) initiate an API call to the user service 222 of the cloud manager 230 to revert an operation, and (4) update a status of a workflow in a database (e.g., workflow database) associated with the step functions of the cloud service. In some embodiments, the cloud service includes a workflow database. The workflow database stores a current state of the workflow. In some embodiments, the workflow database serves as a storage for locking a cloud user-cloud site combination, ensuring that parallel user requests for the same cloud user-cloud site combination do not execute concurrently. For example, while a workflow for updating user information associated with a respective user record is currently active, in accordance with a determination that another workflow that is associated with the respective user record is also active, the cloud manager 230 aborts the workflow via the step functions of the cloud service. Accordingly, the workflow database of the cloud service is updated to reflect the abortion of the workflow.

In some embodiments, a cloud management system (e.g., cloud management systems 100 and 200) and/or a cloud platform (e.g., cloud platform 150) implements a synchronization protocol corresponding to a saga based approach. The saga based approach includes a design pattern for managing transactions/steps of a comprehensive transaction across services or components. Under the synchronization protocol, a cloud service acts as orchestrator. Step functions of the cloud service orchestrate a series of separate transactions across the cloud user management system, and in the event of a failure, executes corresponding rollback operations to ensure consistency and integrity. In particular, the use of step functions provides a standardized infrastructure for tracking workflows, such as tracking status of a workflow executing user changes. In some embodiments, all transactions including rollback operations (e.g., during a failure) are committed and become visible to a customer as soon as they are completed. In some embodiments, a workflow based on the synchronization protocol includes: (i) upon initiation of the workflow, the cloud manager 230 marks the workflow in a database (e.g., a database associated with the cloud manager 230, such as global database 234 in FIG. 2) and aborts the workflow when another workflow is active and operates on the same user record, (ii) the cloud manager 230 of the cloud user management system initiates associated operations and is responsible for updating the database of the cloud service or failing the workflow if licensing constraints prevent operations from being executed, (iii) the pod 240 updates a service record via an API call, (iv) when the process completes, the cloud manager 230 marks the workflow as complete for the user record in the database of the cloud service, (v) in the event of a failure (e.g., when an user information update to the pod 240 fails a predefined number of retries), the cloud manager 230 implements a rollback to restore records with original values. In some embodiments, a caller (e.g., cloud administrator 212) interacts with the cloud service and remains in a waiting status until operations are complete, particularly if a final status update is required before proceeding. For example, operations associated with the pod 240 depend on the final status update, because they cannot be finalized until a current state is fully committed both on the cloud manager 230 and the pod 240. In some embodiments, the synchronization protocol includes a logic for handling retries when a caller is unavailable (e.g., displaying an alarm when a workflow is not completed within a predetermined timeframe). In some embodiments, regardless of where an operation is initiated (e.g., from the cloud manager 230 or from the pod 240) and/or by whichever method (e.g., by the cloud administrator 212 via the cloud administration user interface 202 or by the site administrator 214 via the site administration user interface 204 (e.g., by REST API(s)). The same underlying flow is followed. For example, a caller (e.g., cloud administrator 212 or site administrator 214) initiates a user request to add a new cloud user, remove a cloud user, or edit a cloud user role with respect to one or more sites of the plurality of cloud sites 210. The user request results in an HTTP 202 (e.g., accepted) response, indicating that the user request has been successfully received and is being processed. The user interface (e.g., cloud administration user interface 202, site administration user interface 204) issues a subsequent request to check the status of the operation, which results in an HTTP 200 (e.g., OK) response with a status (e.g., complete, in progress, failed, etc.). In some embodiments, when an operation is initiated from the pod 140 by a caller (e.g., site administrator 114), a status of the operation is polled after an HTTP 202 (e.g., accepted) response is generated.

In some embodiments, a cloud management system (e.g., cloud management systems 100 and 200) and/or a cloud platform (e.g., cloud platform 150) permits a cross-region user update. For example, a user request to update user information can be submitted from a first region while changes needs to be made to user information hosted in other regions. For example, as shown in FIG. 1B, when the cloud manager 130-1 is deployed at the “Region 1” 122-1, a user information update for adding a cloud user to the cloud site 110-1 of the pod 140-2 deployed at the “Region 2” 122-2 triggers a cross-region user update.

In some embodiments, communications between the cloud manager 230 and the pod 240 is based an API authentication mechanism. In some embodiments, a communication between the cloud manager 230 and the pod 240 to is established over an authenticated channel (e.g., mutual transport layer security (mTLS), token-based authentication, API keys) to ensure security and integrity. In some embodiments, in a communication from the cloud manager 230 to the pod 240, the plurality of the cloud sites 210 of the pod 240 are managed via API calls through an API gateway (e.g., part of the gateway service 201). In particular, management of the plurality of cloud sites 210 involves a two-layer secure communication: (1) a mTLS service secures the communication from a customer to the gateway service 201 and (2) session-based authentication based on the session service 216 secures the communication from the gateway service 201 to the pod 140. In some embodiments, a communication between the cloud manager 230 and step functions of a cloud service requires specific permissions that are assigned to trusted identities (e.g., workforce identities, applications, etc.).

In some embodiments, API calls are implemented for communications between customers and the cloud manager 230, including calls to add cloud users, remove cloud users and modify cloud users. In some embodiments, API calls are implemented for the site administration user interface 204, including calls to import external cloud users, delete cloud users, update cloud users' roles for cloud sites, and update cloud users' authentication settings.

FIG. 3 (e.g., FIGS. 3A and 3B) illustrates an example in-region process 300 for synchronizing user information corresponding to an in-region cloud user information update, in accordance with some embodiments. FIG. 3A and FIG. 3B are partial views of FIG. 3 (e.g., FIGS. 3A and 3B form FIG. 3 according to a figure configuration 380 shown in FIG. 3A). In particular, the in-region process 300 illustrates initiating cloud user information update by a caller 320 via a cloud administration user interface 202-A (e.g., similar to cloud administration user interface 202 in FIG. 2). In some embodiments, the cloud administration user interface 202-A is part of a cloud manager. In some embodiments, the caller 320 includes a cloud administrator (e.g., cloud administrator 212).

As shown in FIG. 3, the in-region process 300 and respective cloud user information update are performed within a single region associated with a cloud manager 230-A (e.g., similar to cloud managers in FIGS. 1B and 2), a pod 240-A (e.g., similar to pod in FIGS. 1B and 2), and a cloud service 302-A (e.g., similar to cloud service discussed above). In particular, the cloud manager 230-A and the pod 240-A are deployed at the same region, e.g., “Region A.” The cloud manager 230-A includes cloud administration user interface 202-A, user service 222-A, user storage 310-A, user replication service 232-A, and tenant service 220-A. The user storage 301-A includes a global database 234-A. The cloud service 302-A includes step functions 304-A and a workflow database 306-A. The pod 240-A includes a visualization portal 242-A and a local database 244-A.

In some embodiments, the in-region process 300 includes a first set of operations 310 (e.g., steps 322 to 330) to initiate replication of user information across the pod 240-A where a target cloud site resides. The first set of operations 310 is performed in response to receiving a user request to modify user information from the caller 320. The user request to modify user information is a request to add a respective cloud user (e.g., a new cloud user) to a respective target cloud site deployed on the pod 240-A in “Region A.” The first set of operations 310 of the in-region process 300 adds the respective cloud user to the global database 234-A. The in-region process 300 further includes a second set of operations 312 (e.g., steps 331 to 340), which are coordinated by the step functions 304-A. The second set of operations 312 adds the respective target cloud user to the respective cloud site on the pod 240-A. The in-region process 300 further includes a third set of operations 314 (e.g., steps 341 to 346) performed after the respective cloud user is added to the global database 234-A. The third set of operations 314 includes a first subset operations 314-1 and a second subset operations 314-2. The first subset operations 314-1 corresponds to a rollback process when adding the respective cloud user to the respective cloud site of the pod 240-A failed (e.g., a call from the caller 320 to the pod 240-A fails). The second subset operations 314-2 corresponds to a commit process when adding the respective cloud user to the respective target cloud site of the pod 240-A was successful (e.g., a call from the caller 320 to the pod 240-A was successful). The in-region process 300 further includes a fourth set of operations 316 (e.g., steps 347 to 354) to initialize polling requests for a status associated with the pending cloud user information update. The fourth set of operations 316 repeats until the user request for the in-region is successful. In some embodiments, when the fourth set of operations 316 is executed, the cloud administration user interface 202-A displays to the caller 320 an indication (e.g., a spinning bar) showing a pending status.

In some embodiments, the first set of operations 310, a bundle of the second and third sets of operations 312 and 314, and the fourth set of operations 316 are asynchronous. The asynchronization is to avoid time-out when a cloud user information update consumes excessive amount of time. For example, a call (e.g., user request) from the cloud manager 230-A is not synchronized with the step functions 304-A, such that the second set of operations 312 may be initiated immediately after the completion of the first set of operations 310, or there may be a gap time between the first set of operations 310 and the second set of operations 312. In another example, the fourth set of operations 316 for polling requests for the status does not depend on the completion of either the first set of operations 310 or the bundle of the second and third sets of operations 312 and 314. The fourth set of operations 316 may be initiated immediately after the caller 320 makes a call (e.g., user request for cloud user information update to add the respective cloud user to the respective target cloud site). In some embodiments, the first subset operations 314-1 and the second subset operations 314-2 are mutually exclusive alternatives. In accordance with a determination that the call to the pod 240-A failed, the first subset operations 314-1 are subsequently performed to rollback. In accordance with a determination that the call to the pod 240-A was successful, the second subset operations 314-2 are subsequently performed to commit.

In some embodiments, the caller 320 sends a call as a user request to add a respective cloud user to a respective target cloud site of the pod 240-A (e.g., adding a cloud user to a license for a corresponding target cloud site) via the cloud administration user interface 202-A, e.g., step 321. The call includes a user request for an in-region cloud user information update. In response to receiving the call, the cloud administration user interface 202-A sends the call to the user service 222-A through REST API(s), e.g., step 322. In response to receiving the call, the user service 222-A initiates a request to the user replication service 232-A for replicating the in-region cloud user information update, e.g., step 323. In response to receiving the user replication request, the user replication service 232-A sends a request to the tenant service 220-A for getting region information about the corresponding target cloud site, e.g., step 324. In response to receiving the request, the tenant service 220-A sends the region information (e.g., “Region A”) to the user replication service 232-A, e.g., step 325. In response to receiving the region information, the user replication service 232-A sends a request to the step functions 304-A for starting a replication workflow, e.g., step 326. In response to receiving the request to start the replication workflow, the step functions 304-A send an information indicative of “WORKFLOW STARTED” to the user replication service 232-A, e.g., step 327. In response to receiving the information indicative of “WORKFLOW STARTED,” the user replication service 232-A sends information indicative of “UPDATE IN PROCESS” to the user service 222-A, e.g., step 328. In response to receiving the information indicative of “UPDATE IN PROCESS”, the user service 222-A sends an information indicative of “IN PROCESS” to the cloud administration user interface 202-A, e.g., step 329. In response to receiving the information indicative of “IN PROCESS,” the cloud administration user interface 202-A sends an information indicative of “IN PROCESS” to the caller 320, e.g., step 330.

In some embodiments, subsequent to the step 326 (e.g., the user replication service 232-A sends a request to the step functions 304-A for starting a replication workflow), the step functions 304-A initiate execution of the second set of operations 312 to add the respective cloud user to the corresponding target cloud site of the pod 240-A, e.g., steps 331 to 340. In particular, the step functions 304-A send a request (e.g., information indicative of “PREPARE”) to the user service 222-A for adding the respective cloud user, e.g., step 331. In response to receiving the request to add the respective cloud user, the user service 222-A sends a request to modify site-user information stored in the global database 234-A, e.g., step 332. In some embodiments, the site-user information is stored in a global table of the global database 234-A. In some embodiments, modifying the site-user information in the step 332 is to make temporary changes to the global table. In response to receiving the request to modify the site-user information, the global database 234-A sends an OK status to the user service 222-A, e.g., step 333. In response to receiving the OK status, the user service 222-A sends an OK status to the step functions 304-A, e.g., step 334. In response to receiving the OK status, the step functions 304-A send a request to the user replication service 232-A for adding the respective cloud user to the corresponding target cloud site of the pod 240-A (e.g., in “Region A”), e.g., step 335. In response to receiving the request for adding the respective cloud user to the corresponding target cloud site of the pod 240-A, the user replication service 232-A sends a request to the visualization portal 242-A for adding the respective cloud user, e.g., step 336. In response to receiving the request for adding the respective cloud user, the visualization portal 242-A executes an operation to insert the respective cloud user to the local database 244-A associated with the corresponding target cloud site, e.g., step 337. In response to the operation to insert the respective cloud user, the local database 244-A sends an OK status to the visualization portal 242-A, e.g., step 338. In response to receiving the OK status, the visualization portal 242-A sends an OK status to the user replication service 232-A, e.g., step 339. In response to receiving the OK status, the user replication service 232-A sends an OK status to the step functions 304-A, e.g., step 340.

In some embodiments, in accordance with a determination that the call from the cloud manager 230-A (e.g., in “Region A”) to the pod 240-A (e.g., in “Region A”) failed (e.g., in an event of a failure), the cloud manager 230-A executes the first subset of operations 314-1 (e.g., rollback operations), e.g., steps 341-344. In particular, the step functions 304-A initiate a request to modify or revert a current status of the cloud manager 230-A when the in-region cloud user information update initiated by the caller 320 via the cloud administration user interface 202-A failed, e.g., step 341. In response to receiving the request, the user service 222-A initiates an operation to modify the site-user information stored in the global database 232-A (e.g., rollbacking the temporary changes made to the global table of the global database 234-A), e.g., step 342. In response to the completion of rollbacking the site-user information, the global database 232-A sends an OK status to the user service 222-A, e.g., step 343. In response to receiving the OK status, the user service 222-A sends an OK status to the step functions 304-A, e.g., step 344. Alternatively, in some embodiments, in accordance with a determination that the call from the cloud manager 230-A (e.g., in “Region A”) to the pod 240-A (e.g., in “Region A”) was successful (e.g., in an event of a success), the step functions 304-A send an information indicative to the user service 222-A indicating that the call is committed, e.g., step 345. In response to receiving the information indicative, the user service 222-A sends an OK status to the step functions 304-A.

In some embodiments, subsequent to or concurrently with the step 321 when the caller 320 initiates the call (e.g., a user request) to add the respective cloud user to the corresponding target cloud site of the pod 240-A, the caller 320 initiates the fourth set of operations 316 for polling requests for the status corresponding to the in-region cloud user information update, e.g., steps 347-354. The fourth set of operations 316 is repeated until the status returns to the caller 320 with an information indicative of “COMPLETED.” In particular, the caller 320 initiates polling requests for the status through the cloud administration user interface 202-A, e.g., step 347. In response to receiving polling requests, the cloud administration user interface 202-A polls for the status through the user service 222-A, e.g., step 348. In response to receiving the polling requests, the user service 222-A sends a request to the user replication service 232-A for polling the status, e.g., step 349. In response to receiving the request for polling the status, the user replication service 232-A sends a request to the workflow database 306-A for reading the status, e.g., step 350. In response to receiving the request for reading the status, the workflow database 306-A sends an information indicative of “SUCCESS” to the user replication service 232-A, e.g., step 351. In response to receiving the information indicative of “SUCCESS,” the user replication service 232-A sends an information indicative of “COMPLETED” to the user service 222-A, e.g., step 352. In response to receiving the information indicative of “COMPLETED,” the user service 222-A sends an information indicative of “COMPLETED” to the cloud administration user interface 202-A, e.g., step 353. In response to receiving the information indicative of “COMPLETED,” the cloud administration user interface 202-A sends an information indicative of “COMPLETED” to the caller 320, e.g., step 354.

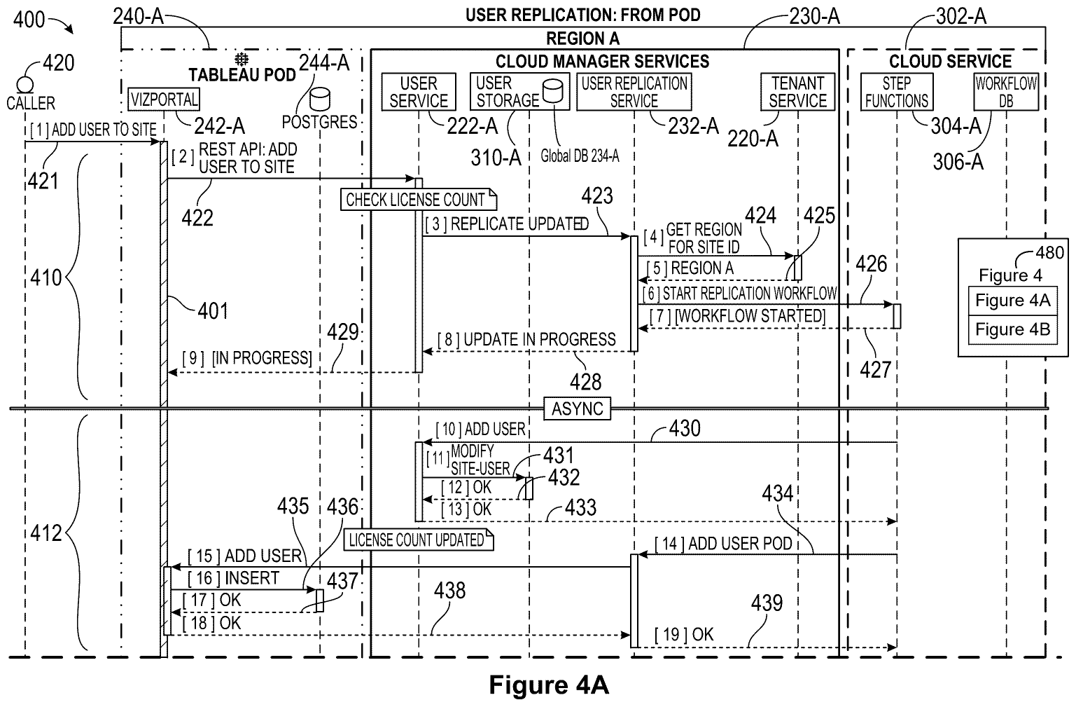

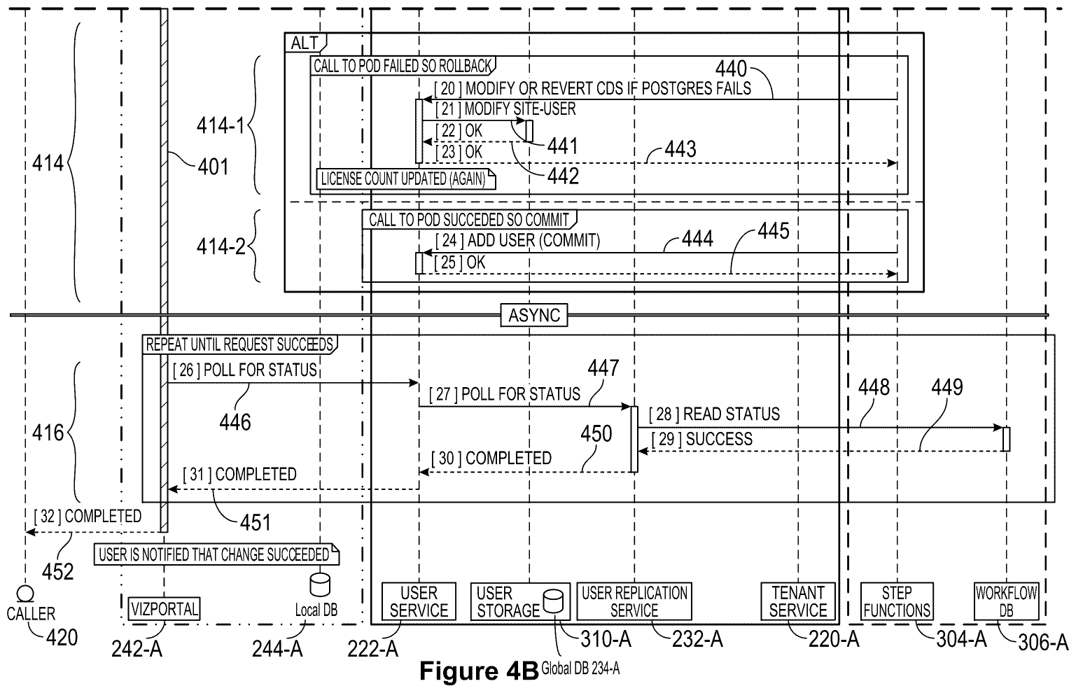

FIG. 4 (e.g., FIGS. 4A and 4B) illustrates another example in-region process 400 for synchronizing user information corresponding to an in-region cloud user information update, in accordance with some embodiments. FIG. 4A and FIG. 4B are partial views of FIG. 4 (e.g., FIGS. 4A and 4B form FIG. 4 according to a figure configuration 480 shown in FIG. 4A). In particular, the in-region process 400 illustrates initiating cloud user information update by a caller 420 via a site administration user interface (e.g., similar to site administration user interface 204 in FIG. 2). Similar to the in-region process 300, the in-region process 400 and respective cloud user information update are performed within a single region associated with a cloud manager 230-A (e.g., similar to cloud managers in FIGS. 1B-3B), a pod 240-A (e.g., similar to pod in FIGS. 1B-3B), and a cloud service 302-A (e.g., similar to cloud service discussed above). In particular, the cloud manager 230-A and the pod 240-A are deployed at the same region, e.g., “Region A.” Different from the in-region process 300, the in-region process 400 is initiated from the pod 240-A. In some embodiments, the caller 320 includes a cloud administrator (e.g., cloud administrator 212). In some embodiments, the caller 420 includes a site administrator (e.g., site administrator 114).

In some embodiments, the in-region process 400 includes a first set of operations 410 (e.g., steps 422 to 429) to initiate replication of user information, across the pod 240-A where a target cloud site resides. The first set of operations 410 is performed in response to receiving a user request to modify user information from the caller 420. The user request to modify user information is a request to add a respective cloud user (e.g., a new cloud user) to a respective target cloud site deployed on the pod 240-A in “Region A.” The first set of operations 410 of the in-region process 400 adds the respective cloud user to the global database 234-A. The in-region process 400 further includes a second set of operations 412 (e.g., steps 430 to 439), which are coordinated by the step functions 304-A, to add the respective cloud user to the respective cloud site. The second set of operations 412 adds the respective cloud user to the respective target cloud site on the pod 240-A. The in-region process 400 further includes a third set of operations 414 (e.g., steps 440 to 445) performed after the respective cloud user is added to the global database 234-A. The third set of operations 414 includes a first subset operations 414-1 and a second subset operations 414-2. The first subset operations 414-1 corresponds to a rollback process when adding the respective cloud user to the respective target cloud site of the pod 240-A failed (e.g., a call from the caller 420 to the pod 240-A failed). The second subset operations 414-2 corresponds to a commit process when adding the respective cloud user to the respective target cloud site of the pod 140 was successful (e.g., a call from the caller 420 to the pod 240-A was successful). The in-region process 400 further includes a fourth set of operations 416 (e.g., steps 446 to 451) to initialize polling requests for a status associated with the pending cloud user information update. The fourth set of operations 416 repeats until the user request for the in-region cloud user information update is successful. Different from the fourth set of operations 316 of the in-region process 300, the fourth set of operations 416 of the in-region process 400 is driven by the visualization portal 242-A instead of the caller 420. Stated another way, the caller 420 only receives an information indicative when the in-region cloud user information update is completed (e.g., no pending status such as a spinning bar is displayed to the caller 420).

In some embodiments, the first set of operations 410, a bundle of the second and third sets of operations 412 and 414, and the fourth set of operations 416 are asynchronous. The asynchronization is to avoid time-out when a cloud user update consumes excessive amount of time. For example, a call (e.g., user request) from the cloud manager 230-A is not synchronized with the step functions 302-A, such that the second set of operations 412 may be initiated immediately after the completion of the first set of operations 410, or there may be a gap time between the first set of operations 410 and the second set of operations 412. In another example, the fourth set of operations 416 for polling requests for the status does not depend on the completion of either the first set of operations 410 or the buddle of the second and third sets of operations 412 and 414. The fourth set of operations 416 may be initiated immediately after the visualization portal 242-A receives a call (e.g. user request for cloud user information update to add the respective cloud user to the respective target cloud site) from the caller 420. In some embodiments, the first subset operations 414-1 and the second subset operations 414-2 are mutually exclusive alternatives. In accordance with a determination that the call to the pod 240-A failed, the first subset operations 414-1 are subsequently performed to rollback. In accordance with a determination that the call to the pod 240-A was successful, the second subset operations 414-2 are subsequently performed to commit.

In some embodiments, the operations associated with the first to fourth sets of operations 410 to 416 are synchronous from a perspective of the caller 420 (e.g., represented by a vertical bar 401). Specifically, the visualization portal 242-A polls a status of a replication workflow (e.g., the fourth set of operations 416) before a response is sent back to the caller 420. Because the replication workflow is asynchronous (e.g., to maintain backward compatibility), it introduces additional latency is increased for the APIs of the visualization portal 242-A. However, a call from the caller 420 is not time out. In some embodiments, the timeout for the APIs of the visualization portal 242-A is within a range of a few hours (e.g., up to two hours).

In some embodiments, the caller 420 sends a call as a user request to add a respective cloud user to a respective cloud site of the pod 240-A (e.g., adding a cloud user to a license for a corresponding target cloud site) via the visualization portal 242-A, e.g., step 421. The call includes a user request for the in-region cloud user information update. In response to receiving the call, the visualization portal 242-A sends the call to the user service 222-A through REST API(s), e.g., step 422. In response to receiving the call, the user service 222 initiates a request to the user replication service 232-A for replicating the in-region cloud user information update, e.g., step 423. In response to receiving the user replication request, the user replication service 232-A sends a request to the tenant service 220-A for getting region information about the corresponding target cloud site, e.g., step 424. In response to receiving the request, the tenant service 220-A sends the region information (e.g., “Region A”) to the user replication service 232-A, e.g., step 425. In response to receiving the region information, the user replication service 232-A sends a request to the step functions 304-A for starting a replication workflow, e.g., step 426. In response to receiving the request to start the replication workflow, the step functions 304-A send an information indicative of “WORKFLOW STARTED” to the user replication service 232-A, e.g., step 427. In response to receiving the information indicative of “WORKFLOW STARTED,” the user replication service 232-A sends information indicative of “UPDATE IN PROCESS” to the user service 222-A, e.g., step 428. In response to receiving the information indicative of “UPDATE IN PROCESS”, the user service 222-A sends an information indicative of “IN PROCESS” to the visualization portal 242-A, e.g., step 429. In some embodiments, the first set of operations 410 of the in-region process 400 does not include an operation, subsequent to the step 429, to send an information indicative to the caller 420.

In some embodiments, subsequent to the step 426 (e.g., the user replication service 232-A sends a request to the step functions 304-A for starting a replication workflow), the step functions 304-A initiate execution of the second set of operations 412 to add the respective cloud user to the corresponding cloud site of the pod 240-A, e.g., steps 430 to 439. In particular, the step functions 304-A send a request (e.g., together with an information indicative) to the user service 222-A for adding the respective cloud user, e.g., step 430. In response to receiving the request to add the respective cloud user, the user service 222-A sends a request to modify site-user information stored in the global database 234-A, e.g., step 431. In some embodiments, the site-user information is stored in a global table of the global database 234-A. In some embodiments, modifying the site-user information in the step 431 is to make temporary changes to the global table. In response to receiving the request to modify the site-user information, the global database 234-A sends an OK status to the user service 222-A, e.g., step 432. In response to receiving the OK status, the user service 222-A sends an OK status to the step functions 304-A, e.g., step 433. In response to receiving the OK status, the step functions 304-A send a request to the user replication service 232-A for adding the respective cloud user to the corresponding target cloud site of the pod 240-A (e.g., in “Region A”), e.g., step 434. In response to receiving the request for adding the respective cloud user to the corresponding cloud site of the pod 240-A, the user replication service 232-A sends a request to the visualization portal 242-A for adding the respective cloud user, e.g., step 435. In response to receiving the request for adding the respective cloud user, the visualization portal 242-A executes an operation to insert the respective cloud user to the local database 244-A associated with the corresponding cloud site, e.g., step 436. In response to the operation to insert the respective cloud user, the local database 244-A sends an OK status to the visualization portal 242-A, e.g., step 437. In response to receiving the OK status, the visualization portal 242-A sends an OK status to the user replication service 232-A, e.g., step 438. In response to receiving the OK status, the user replication service 232-A sends an OK status to the step functions 304-A, e.g., step 439.

In some embodiments, in accordance with a determination that the call from the cloud manager 230-A (e.g., in “Region A”) to the pod 240-A (e.g., in “Region A”) failed (e.g., in an event of a failure), the cloud manager 230-A executes the first subset of operations 414-1 (e.g., rollback operations), e.g., steps 440-445. In particular, the step functions 304-A initiate a request to modify or revert a current status of the cloud manager 230-A when the in-region cloud user information update initiated by the caller 420 via the visualization portal 242-A failed, e.g., step 440. In response to receiving the request, the user service 222-A initiates an operation to modify site-user information stored in the global database 234-A (e.g., rollbacking the temporary changes made to the global table of the global database 234-A), e.g., step 441. In response to the completion of rollbacking the site-user information, the global database 232-A sends an OK status to the user service 222-A, e.g., step 442. In response to receiving the OK status, the user service 222-A sends an OK status to the step functions 304-A, e.g., step 443. Alternatively, in some embodiments, in accordance with a determination that the call from the cloud manager 230-A (e.g., in “Region A”) to the pod 240-A (e.g., in “Region A”) was successful (e.g., in an event of a success), the step functions 304-A send an information indicative to the user service 222-A indicating that the call is committed, e.g., step 444. In response to receiving the information indicative, the user service 222-A sends an OK status to the step functions 304-A.

In some embodiments, subsequent to or concurrently with the step 422 when the visualization portal 242-A sends the call to the user service 222 through REST API(s), the visualization portal 242-A initiates the fourth set of operations 416 for polling requests fro the status corresponding to the in-region cloud user information update, e.g., steps 446-451. The fourth set of operations 316 is repeated until the status returns to the caller 420 with an information indicative of “COMPLETED.” In particular, the visualization portal 242-A initiates polling requests for the status to the user service 222-A, e.g., step 446. In response to receiving polling requests, the user service 222-A sends a request to the user replication service 232-A for polling the status, e.g., step 447. In response to receiving the request for polling the status, the user replication service 232-A sends a request to the workflow database 306-A for reading the status, e.g., step 448. In response to receiving the request for reading the status, the workflow database 306-A sends an information indicative of “SUCCESS” to the user replication service 232-A, e.g., step 449. In response to receiving the information indicative of “SUCCESS,” the user replication service 232-A sends an information indicative of “COMPLETED” to the user service 222-A, e.g., step 450. In response to receiving the information indicative of “COMPLETED,” the user service 222-A sends an information indicative of “COMPLETED” to the visualization portal 242-A, e.g., step 451. In response to receiving the information indicative of “COMPLETED,” the visualization portal 242-A sends an information indicative of “COMPLETED” to the caller 420, e.g., step 452. In some embodiments, the step 452 is triggered only when the cross-region cloud user information update is fully completed (e.g., in an event of a success or in an event of a success).

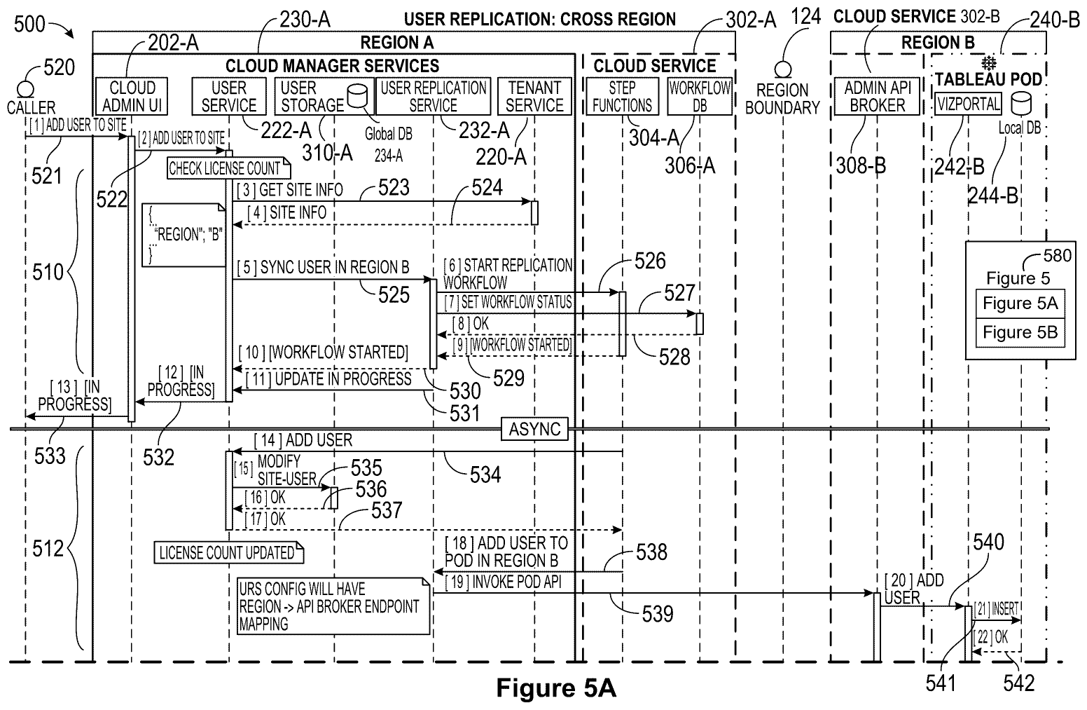

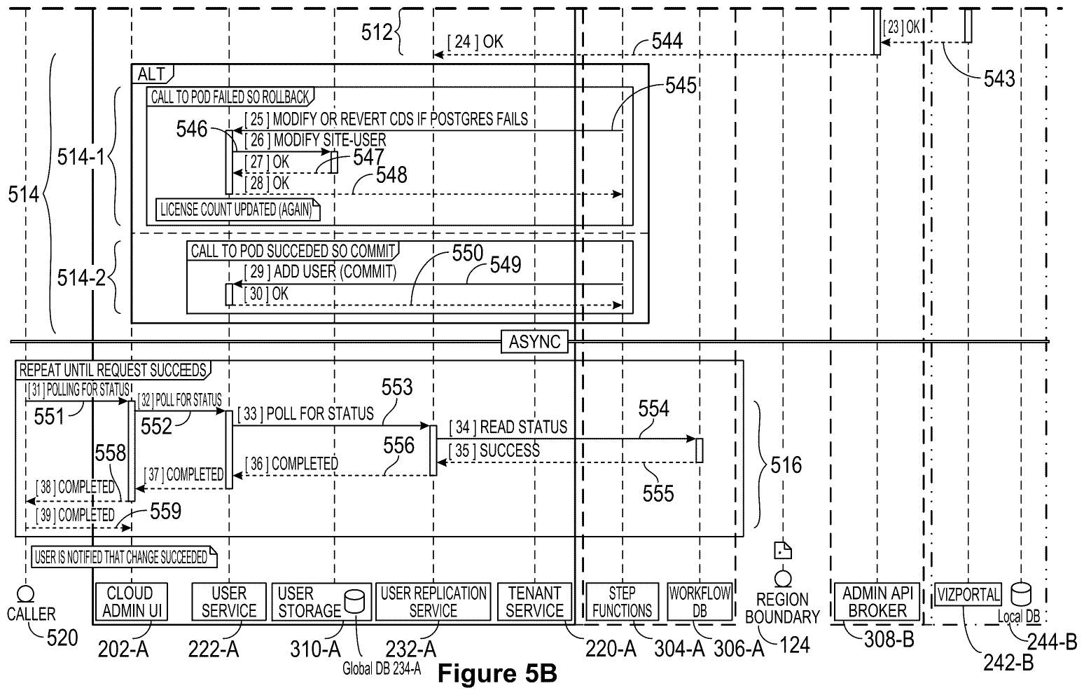

FIG. 5 (e.g., FIGS. 5A and 5B) illustrates an example cross-region process 500 for synchronizing user information corresponding to a cross-region cloud user information update, in accordance with some embodiments. FIG. 5A and FIG. 5B are partial views of FIG. 5 (e.g., FIGS. 5A and 5B form FIG. 5 according to a figure configuration 580 shown in FIG. 5A). In particular, the cross-region process 500 illustrates initiating cloud user information update by a caller 520 via a cloud administration user interface 202-A (e.g., similar to cloud administration user interface 202 in FIG. 2). In some embodiments, the cloud administration user interface 202-A is part of a cloud manager. In some embodiments, the caller 520 includes a cloud administrator (e.g., cloud administrator 212).

As shown in FIG. 5, the cross-region process 500 and respective cloud user information update are performed within two regions separated by the region boundary 124 (e.g., “Region A” and “Region B”) associated with a cloud manager 230-A (e.g., similar to cloud managers in FIGS. 1B-4B), a pod 240-B (e.g., similar to pod in FIGS. 1B-4B), and cloud services 302-A and 302-B (e.g., similar to cloud service discussed above). In particular, the cloud manager 230-A and the pod 240-B are deployed at different regions, e.g., the cloud manager 230-A in “Region A” and the pod 240-B in “Region B.” The cloud manager 230-A, deployed at “Region A,” includes cloud administration user interface 202-A, user service 222-A, user storage 310-A, user replication service 232-A, and tenant service 220-A. The user storage 301-A includes a global database 234-A. The cloud service 302-A, deployed at “Region A,” includes step functions 304-A and a workflow database 306-A. The cloud service 302-B, deployed at “Region B,” includes an administrative API broker 308. The administrative API broker 308 is configured to manage settings of the cloud service 302-B. The pod 240-B, deployed at “Region B,” includes a visualization portal 242-B and a local database 244-B. In some embodiments, the user replication service 232-A of the cloud manager 230-A in “Region A” is a proxy of the counterpart user replication service of the cloud manager in “Region B.” In some embodiments, the global database 234-A uses a global table, and a change made in “Region B” is automatically replicated in “Region A.” In some embodiments, the cross-region cloud user information update cannot be initiated from a pod (e.g., pod 240-B).

In some embodiments, the cross-region process 500 includes a first set of operations 510 (e.g., steps 522 to 533) to initiate user replication of user information across the pod 240-B where a target cloud site resides. The first set of operations 510 is performed in response to receiving a user request to modify user information from the caller 520. The user request to modify user information is a request to add a respective cloud user (e.g., a new cloud user) to a respective target cloud site deployed on the pod 240-B in “Region B.” The first set of operations 510 of the cross-region process 500 adds the respective cloud user to the global database 234-A. The cross-region process 500 further includes a second set of operations 512 (e.g., steps 534 to 544), which are coordinated by the step functions 304-A. The cross-region process 500 further includes a third set of operations 514 (e.g., steps 545 to 550) performed after the respective cloud user is added to the global database 234-A. The third set of operations 514 includes a first subset operations 514-1 and a second subset operations 514-2. The first subset operations 514-1 corresponds to a rollback process when adding the respective cloud user to the respective target cloud site of the pod 140 failed (e.g., a call from the caller 520 to the pod 240-B failed). The second subset operations 514-2 corresponds to a commit process when adding the respective cloud user to the respective target cloud site of the pod 240-B was successful (e.g., a call from the caller 520 to the pod 240-B was successful). The cross-region process 500 further includes a fourth set of operations 516 to initialize polling requests for a status associated with the pending cloud user information update. The fourth set of operations 516 repeats until the user request for the cross-region cloud user information update 501 is successful. In some embodiments, when the fourth set of operations 516 is executed, the cloud administration user interface 202-A displays to the caller 520 an indication (e.g., a spinning bar) showing a pending status.

In some embodiments, the first set of operations 510, the bundle of the second and third sets of operations 512 and 514, and the fourth set of operations 516 are asynchronous. The asynchronization is to avoid time-out when a cloud user update consumes excessive amount of time. For example, a call (e.g., user request) from the cloud manager 230-A is not synchronized with the step functions 304-A, such that the second set of operations 512 may be initiated immediately after the completion of the first set of operations 510, or there may be a gap time between the first set of operations 510 and the second set of operations 512. In another example, the fourth set of operations 516 for polling requests for the status does not depend on the completion of either the first set of operations 510 or the bundle of the second and third sets of operations 512 and 514. The fourth set of operations 516 may be initiated immediately after the caller 520 makes a call (e.g., user request). In some embodiments, the first subset operations 514-1 and the second subset operations 514-2 are mutually exclusive alternatives. In accordance with a determination that the call to the pod 240-B failed, the first subset operations 514-1 are subsequently performed to rollback. In accordance with a determination that the call to the pod 140 was successful, the second subset operations 514-2 are subsequently performed to commit.

In some embodiments, the caller 520 sends a call as a user request to add a respective cloud user to a respective cloud site of the pod 240-B (e.g., adding a cloud user to a license for a corresponding target cloud site) via the cloud administration user interface 202-A, e.g., step 521. The call includes a user request for a cross-region cloud user information update. In response to receiving the call, the cloud administration user interface 202-A sends the call to the user service 222-A through REST API(s), e.g., step 522. In response to receiving the call, the user service 222-A sends a request to the tenant service 220-A for obtaining site information of the respective target cloud site of the pod 240-B, e.g., step 523. In response to receiving the request for obtaining the site information, the tenant service 220-A send the site information (e.g., the respective target cloud site is deployed at “Region B”) to the user service 222-A, e.g., step 524. In response to receiving the site information, the user service 222-A initiates a request to the user replication service 232-A for replicating the cross-region cloud user information update, e.g., step 525. In response to receiving the user replication request, the user replication service 232-A sends a request to the steps function 304-A for starting a replication workflow, e.g., step 526. Sequentially or concurrently, the user replication service 232-A sends a request to the workflow database 306-A for setting a status of the replication workflow, e.g., step 527. In response to receiving the request for setting the status of the replication workflow, the workflow database 306-A sends an OK status to the user replication service 232-A, e.g., step 528. Sequentially or concurrently, in response to receiving the request for starting the replication workflow, the step functions 304 send an information indicative of “WORKFLOW STARTED” to the user replication service 232-A, e.g., step 529. In response to receiving the information indicative of “WORKFLOW STARTED,” the user replication service 232-A sends an information indicative of “WORKFLOW STARTED” to the user service 222-A, e.g., step 530. Sequentially or concurrently, the user replication service 232-A sends information indicative of “UPDATE IN PROCESS” to the user service 222-A, e.g., step 531. In response to receiving the information indicative of “UPDATE IN PROCESS”, the user service 222-A sends an information indicative of “IN PROCESS” to the cloud administration user interface 202-A, e.g., step 532. In response to receiving the information indicative of “IN PROCESS,” the cloud administration user interface 202-A sends an information indicative of “IN PROCESS” to the caller 320, e.g., step 533.

In some embodiments, subsequent to the step 526 (e.g., the user replication service 232-A sends a request to the step functions 304-A for starting a replication workflow), the step functions 304-A initiate execution of the second set of operations 512 to add the respective cloud user to the corresponding target cloud site of the pod 240-B, e.g., steps 534 to 544. In particular, the step functions 304 send a request (e.g., information indicative of “PREPARE”) to the user service 222-A for adding the respective cloud user, e.g., step 534. In response to receiving the request to add the respective cloud user, the user service 222-A sends a request to modify site-user information stored in the global database 234-A, e.g., step 535. In some embodiments, the site-user information is stored in a global table of the global database 234-A. In some embodiments, modifying the site-user information in the step 535 is to make temporary changes to the global table. In response to receiving the request to modify the site-user information, the global database 234-A sends an OK status to the user service 222-A, e.g., step 536. In response to receiving the OK status, the user service 222-A sends an OK status to the step functions 304-A, e.g., step 537. In response to receiving the OK status, the step functions 304-A send a request to the user replication service 232-A for adding the respective cloud user to the corresponding target cloud site of the pod 240-B (e.g., in “Region B”), e.g., step 538. In response to receiving the request for adding the respective cloud user to the corresponding target cloud site of the pod 240-B, the user replication service 232-A sends a request to the administrative API broker 308-B for initiating a process to invoke API(s) of the pod 240-B, e.g., step 539. In response to receiving the request for initiating a process to invoke the API(s) of the pod 240-B, the administrative API broker 308-B sends a request to the visualization portal 242-B for adding the respective cloud user, e.g., step 540. In response to receiving the request for adding the respective cloud user, the visualization portal 242-B executes an operation to insert the respective cloud user to the local database 244-B associated with the corresponding target cloud site, e.g., step 541. In response to the operation to insert the respective cloud user, the local database 244-B sends an OK status to the visualization portal 242-B, e.g., step 542. In response to receiving the OK status, the visualization portal 242-B sends an OK status to the administrative API broker 308-B, e.g., step 543. In response to receiving the OK status, the administrative API broker 308-B sends an OK status to the user replication service 232-A, e.g., step 544.

In some embodiments, in accordance with a determination that the call from the cloud manager 230-A (e.g., in “Region A”) to the pod 240-B (e.g., in “Region B”) failed (e.g., in an event of a failure), the cloud manager 230-A executes the first subset of operations 514-1 (e.g., rollback operations), e.g., steps 545-548. In particular, the step functions 304-A initiate a request to modify or revert a current status of the cloud manager 230-A when the cross-region cloud user information update initiated by the caller 520 via the cloud administration user interface 202-A failed, e.g., step 545. In response to receiving the request, the user service 222-A initiates an operation to modify site-user information stored in the global database 234-A (e.g., rollbacking the temporary changes made to the global table of the global database 234-A), e.g., 546. In response to the completion of rollbacking the site-user information, the global database 232-A sends an OK status to the user service 222-A, e.g., step 547. In response to receiving the OK status, the user service 222 sends an OK status to the step functions 304-A, e.g., step 548. Alternatively, in some embodiments, in accordance with a determination that the call from the cloud manager 230-A (e.g., in “Region A”) to the pod 240-B (e.g., in “Region B”) was successful (e.g., in an event of a success), the step functions 304-A send an information indicative to the user service 222-A indicating that the call is committed, e.g., step 549. In response to receiving the information indicative, the user service 222-A sends an OK status to the step functions 304-A.

In some embodiments, subsequent to or concurrently with the step 521 when the caller 520 initiates the call (e.g., a user request) to add the respective cloud user to the corresponding target cloud site of the pod 240-B, the caller 520 initiates the fourth set of operations 516 for polling requests for the status corresponding to the cross-region cloud user information update, e.g., steps 551-559. The fourth set of operations 516 is repeated until the status returns to the caller 520 with an information indicative of “COMPLETED.” In particular, the caller 320 initiates polling requests for the status through the cloud administration user interface 202-A, e.g., step 551. In response to receiving polling requests, the cloud administration user interface 202-A polls for the status through the user service 222-A, e.g., step 552. In response to receiving the polling request, the user service 222-A sends a request to the user replication service 232-A for polling the status, e.g., step 553. In response to receiving the request for polling the status, the user replication service 232-A sends a request to the workflow database 306 for reading the status, e.g., step 554. In response to receiving the request for reading the status, the workflow database 306-A sends an information indicative of “SUCCESS” to the user replication service 232-A, e.g., step 555. In response to receiving the information indicative of “SUCCESS,” the user replication service 232-A sends an information indicative of “COMPLETED” to the user service 222-A, e.g., step 556. In response to receiving the information indicative of “COMPLETED,” the user service 222-A sends an information indicative of “COMPLETED” to the cloud administration user interface 202-A, e.g., step 557. In response to receiving the information indicative of “COMPLETED,” the cloud administration user interface 202-A sends an information indicative of “COMPLETED” to the caller 520, e.g., step 558. In response to receiving the information indicative of “COMPLETED,” the caller 520 sends an information indicative of “COMPLETED” to the cloud administration user interface 202-A, e.g., step 559.

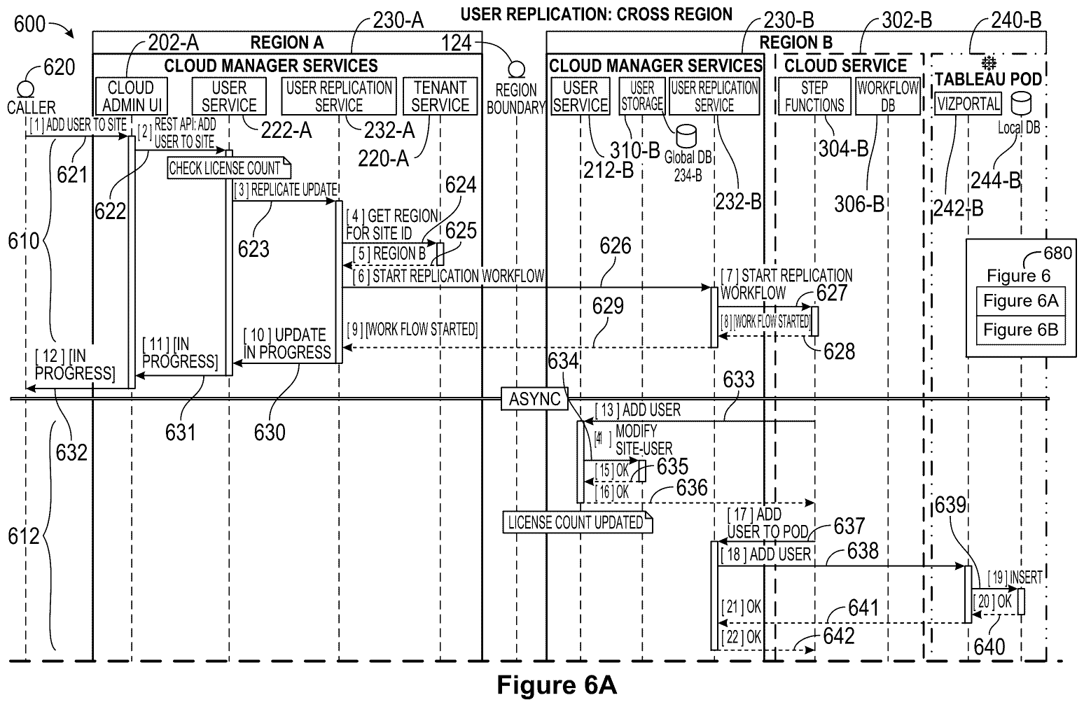

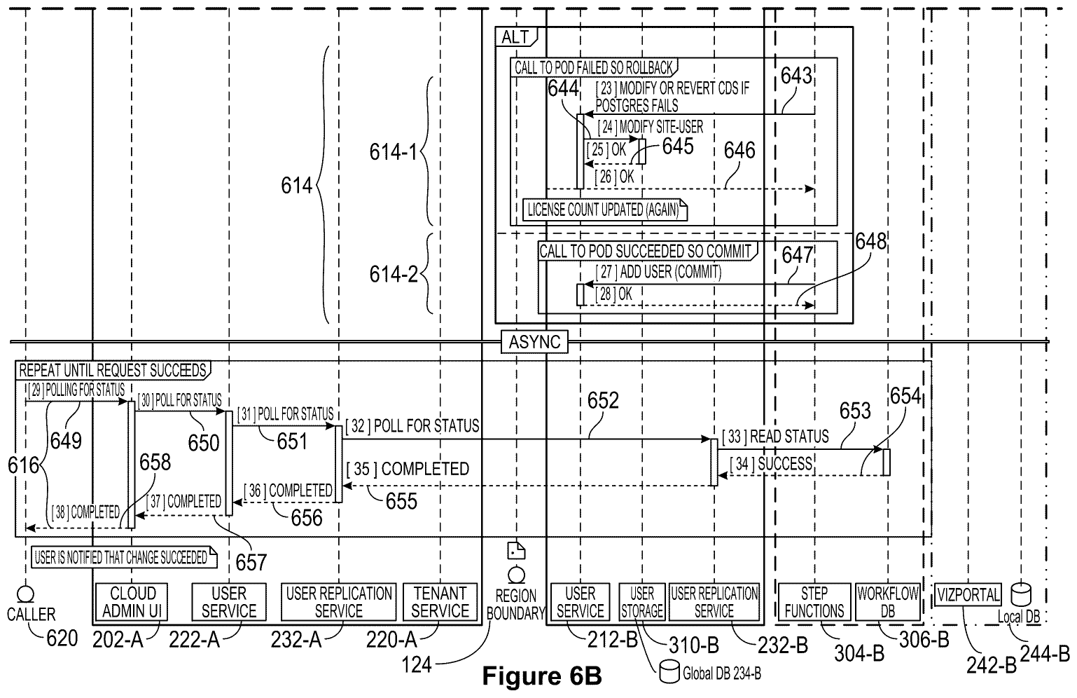

FIG. 6 (e.g., FIGS. 6A and 6B) illustrates another example cross-region process 600 for synchronizing user information corresponding to a cross-region cloud user information update, in accordance with some embodiments. FIG. 6A and FIG. 6B are partial views of FIG. 6 (e.g., FIGS. 6A and 6B form FIG. 6 according to a figure configuration 680 shown in FIG. 6A). In particular, the cross-region process 600 illustrates initiating cloud user information update by a caller 620 via a cloud administration user interface 202-A (e.g., similar to cloud administration user interface 202 in FIG. 2). In some embodiments, the cloud administration user interface 202-A is part of a cloud manager. In some embodiments, the caller 620 includes a cloud administrator (e.g., cloud administrator 212).

Similar to the cross-region process 500, the cross-region process 600 and respective cloud user information update are performed within two regions separated by the region boundary 124 (e.g., “Region A” and “Region B”) associated with cloud managers 230-A and 230-B (e.g., similar to cloud managers in FIGS. 1B-5B), a pod 240-B (e.g., similar to pod in FIGS. 1B-5B), and a cloud service 302-B (e.g., similar to cloud service discussed above). In particular, the cloud manager 230-A is deployed at “Region A,” and the cloud manager 230-B and the pod 240-B are deployed at “Region B” different from “Region A.” The cloud manager 230-A, deployed at “Region A,” includes cloud administration user interface 202-A, user service 222-A, user replication service 232-A, and tenant service 220-A. The cloud manager 230-B, deployed at “Region B,” includes user service 222-B, user storage 310-B, and user replication service 232-B. The user storage 301-B includes a global database 234-B. The cloud service 302-B, deployed at “Region B,” includes step functions 304-B and a workflow database 306-B. The pod 240-B, deployed at “Region B,” includes a visualization portal 242-B and a local database 244-B.

In some embodiments, the cloud manager 230-B is a replica of the cloud manager 230-B (e.g., in reference to FIG. 1B). In some embodiments, as shown in FIG. 6, a user replication is driven by the user replication service 232-B of the cloud manager 230-B in “Region B,” and thus the user replication service 232-A of the cloud manager 230-A in “Region A” is no longer a proxy of the counterpart user replication service 232-B. In some embodiments, the global database 234-A uses a global table, and a change made in “Region B” is automatically replicated in “Region A.” In some embodiments, the cross-region cloud user information update cannot be initiated from a pod (e.g., pod 240-B).

In some embodiments, the cross-region process 600 includes a first set of operations 610 (e.g., steps 622 to 632) to initiate user replication of user information across the pod 240-B where a target cloud site resides. The first set of operations 610 is performed in response to receiving a user request to modify user information from the caller 520. The user request to modify user information is a request to add a respective cloud user (e.g., a new cloud user) to a respective target cloud site deployed on the pod 240-B in “Region B.” The first set of operations 610 of the cross-region process 600 adds the respective cloud user to the global database 234-B. The cross-region process 600 further includes a second set of operations 612 (e.g., steps 633 to 642), which are coordinated by the step functions 304-B, to add the respective cloud user to the respective target cloud site. The cross-region process 600 further includes a third set of operations 614 (e.g., steps 643 to 648) performed after the respective cloud user is added to the global database 234-B. The third set of operations 614 includes a first subset operations 614-1 and a second subset operations 614-2. The first subset operations 614-1 corresponds to a rollback process when adding the respective cloud user to the respective cloud site of the pod 240-B failed (e.g., a call from the caller 620 to the pod 240-B failed). The second subset operations 614-2 corresponds to a commit process when adding the respective cloud user to the respective cloud site of the pod 240-B was successful (e.g., a call from the caller 620 to the pod 240-B was successful). The cross-region process 600 further includes a fourth set of operations 616 (e.g., steps 649 to 658) to initialize polling requests for a status associated with the pending cloud user update. The fourth set of operations 616 repeats until the user request for the example cross-region cloud user update 601 is successful. In some embodiments, when the fourth set of operations 616 is executed, the cloud administration user interface 202-A displays to the caller 620 an indication (e.g., a spinning bar) showing a pending status.

In some embodiments, the first set of operations 610, the bundle of the second and third sets of operations 612 and 614, and the fourth set of operations 616 are asynchronous. The asynchronization is to avoid time-out when a cloud user update consumes excessive amount of time. For example, a call (e.g., user request) from the cloud manager 230-A is not synchronized with the step functions 304-B, such that the second set of operations 612 may be initiated immediately after the completion of the first set of operations 610, or there may be a gap time between the first set of operations 610 and the second set of operations 612. In another example, the fourth set of operations 616 for polling the status does not depend on the completion of either the first set of operations 610 or the bundle of the second and third sets of operations 612 and 614. The fourth set of operations 616 may be initiated immediately after the caller 620 makes a call (e.g., user request). In some embodiments, the first subset operations 614-1 and the second subset operations 614-2 are mutually exclusive alternatives. In accordance with a determination that the call to the pod 240-B failed, the first subset operations 614-1 are subsequently performed to rollback. In accordance with a determination that the call to the pod 240-B was successful, the second subset operations 614-2 are subsequently performed to commit.

In some embodiments, the caller 620 sends a call as a user request to add a respective cloud user to a respective cloud site of the pod 240-B (e.g., adding a cloud user to a license for a corresponding target cloud site) via the cloud administration user interface 202-A, e.g., step 621. The call includes a user request for the cross-region cloud user information update. In response to receiving the call, the cloud administration user interface 202-A sends the call to the user service 222-A through REST API(s), e.g., step 622. In response to receiving the call, the user service 222-A initiate a request to the user replication service 232-A for replicating the cross-region cloud user information update, e.g., step 623. In response to receiving the user replication request, the user replication service 232-A sends a request to the tenant service 220-A for getting region information about the corresponding target cloud site, e.g., step 624. In response to receiving the request, the tenant service 220-A sends the region information (e.g., “Region B”) to the user replication service 232-A, e.g., step 625. In response to receiving the region information, the user replication service 232-A (e.g., in “Region A”) sends a request to the user replication service 232-B (e.g., in “Region B”) for starting a replication workflow, e.g., step 626. In response to receiving the request, the user replication service 232-B sends a request to the step functions 304-B for starting a replication workflow, e.g., step 627. In response to receiving the request to start the replication workflow, the step functions 304-B send an information indicative of “WORKFLOW STARTED” to the user replication service 232-B, e.g., step 628. In response to receiving the information indicative of “WORKFLOW STARTED,” the user replication service 232-B (e.g., in “Region B”) sends an information indicative of “WORKFLOW STARTED” to the user replication service 232-A (e.g., in “Region A”), e.g., step 629. In response to receiving the information indicative of “WORKFLOW STARTED,” the user replication service 232-A sends an information indicative of “UPDATE IN PROCESS” to the user service 222-A, e.g., step 630. In response to receiving the information indicative of “UPDATE IN PROCESS”, the user service 222-A sends an information indicative of “IN PROCESS” to the cloud administration user interface 202-A, e.g., step 631. In response to receiving the information indicative of “IN PROCESS,” the cloud administration user interface 202-A sends an information indicative of “IN PROCESS” to the caller 620, e.g., step 632.

In some embodiments, subsequent to the step 627 (e.g., the user replication service 232-B sends a request to the step functions 304-B for starting a replication workflow), the step functions 304-B initiate execution of the second set of operations 612 to add the respective cloud user to the corresponding target cloud site of the pod 240-B, e.g., steps 633 to 642. In some embodiments, the second set of operations 612 is performed in “Region B.” In particular, the step functions 304-B send a request (e.g., information indicative of “PREPARE”) to the user service 222-B for adding the respective cloud user, e.g., step 633. In response to receiving the request to add the respective cloud user, the user service 222-B sends a request to modify site-user information stored in the global database 234-B, e.g., step 634. In some embodiments, the site-user information is stored in a global table of the global database 234-B. In some embodiments, modifying the site-user information in the step 634 is to make temporary changes to the global table. In response to receiving the request to modify the site-user information, the global database 234-B sends an OK status to the user service 222-B, e.g., step 635. In response to receiving the OK status, the user service 222-B sends an OK status to the step functions 304-B, e.g., step 636. In response to receiving the OK status, the step functions 304-B send a request to the user replication service 232-B for adding the respective cloud user to the corresponding cloud site of the pod 240-B (e.g., in “Region B”), e.g., step 637. In response to receiving the request for adding the respective cloud user to the corresponding cloud site of the pod 240-B, the user replication service 232-B sends a request to the visualization portal 242-B for adding the respective cloud user, e.g., step 638. In response to receiving the request for adding the respective cloud user, the visualization portal 242-B executes an operation to insert the respective cloud user to the local database 244 associated with the corresponding target cloud site, e.g., step 639. In response to the operation to insert the respective cloud user, the local database 244 sends an OK status to the visualization portal 242-B, e.g., step 640. In response to receiving the OK status, the visualization portal 242-B sends an OK status to the user replication service 232-B, e.g., step 641. In response to receiving the OK status, the user replication service 232-B sends an OK status to the step functions 304-B, e.g., step 642.

In some embodiments, in accordance with a determination that the call from the cloud manager 230-A (e.g., in “Region A”) to the pod 240-B (e.g., in “Region B”) via the cloud manager 230-A (e.g., in “Region B”) failed (e.g., in an event of a failure), the cloud manager 230-B executes the first subset of operations 614-1 (e.g., rollback operations), e.g., steps 643-646. In particular, the step functions 304-B initiate a request to modify or revert a current status of the cloud manager 130-B when the example cross-region cloud user update 601 initiated by the caller 320 via the cloud administration user interface 202-A failed, e.g., step 643. In response to receiving the request, the user service 222-B initiates an operation to modify site-user information stored in the global database 234-B (e.g., rollbacking the temporary changes made to the global table of the global database 234-B), e.g., step 644. In response to the completion of rollbacking the site-user information, the global database 232-B sends an OK status to the user service 222-B, e.g., step 645. In response to receiving the OK status, the user service 222-B sends an OK status to the step functions 304-B, e.g., step 646. Alternatively, in some embodiments, in accordance with a determination that the call from the cloud manager 230-A (e.g., in “Region A”) to the pod 240-B (e.g., in “Region B”) via the cloud manager 230-A (e.g., in “Region B”) was successful (e.g., in an event of a success), the step functions 304-B send an information indicative to the user service 222-B indicating that the call is committed, e.g., step 647. In response to receiving the information indicative, the user service 222-B sends an OK status to the step functions 304-B.

In some embodiments, subsequent to or concurrently with the step 621 when the caller 620 initiates the call (e.g., a user request) to add the respective cloud user to the corresponding cloud site of the pod 240-B, the caller 620 initiates the fourth set of operations 616 for polling the status corresponding to the example cross-region cloud user update 601, e.g., steps 649-658. The fourth set of operations 616 is repeated until the status returns to the caller 620 with an information indicative of “COMPLETED.” In particular, the caller 620 initiates polling requests for the status through the cloud administration user interface 202-A, e.g., step 649. In response to receiving polling requests, the cloud administration user interface 202-A polls for the status through the user service 222-A, e.g., step 650. In response to receiving the polling request, the user service 222-A sends a request to the user replication service 232-A for polling the status, e.g., step 651. In response to receiving the request for polling the status, the user replication service 232-A (e.g., in “Region A”) sends a request to the user replication service 232-B (e.g., in “Region B”) for polling the status, e.g., step 652. In response to receiving the request for polling the status, the user replication service 232-B sends a request to the workflow database 306-B for reading the status, e.g., step 653. In response to receiving the request for reading the status, the workflow database 306-B sends an information indicative of “SUCCESS” to the user replication service 232-B, e.g., step 654. In response to receiving the information indicative of “SUCCESS,” the user replication service 232-B (e.g., in “Region B”) sends an information indicative of “COMPLETED” to the user replication service 232-A (e.g., in “Region A”), e.g., step 655. In response to receiving the information indicative of “COMPLETED,” the user replication service 232-A sends an information indicative of “COMPLETED” to the user service 222-A, e.g., step 656. In response to receiving the information indicative of “COMPLETED,” the user service 222-A sends an information indicative of “COMPLETED” to the cloud administration user interface 202-A, e.g., step 657. In response to receiving the information indicative of “COMPLETED,” the cloud administration user interface 202-A sends an information indicative of “COMPLETED” to the caller 620, e.g., step 658.

FIGS. 7A-7D illustrate example graphical user interfaces 700 of a cloud management system (e.g., cloud management systems 100 and 200) for updating user information, in accordance with some embodiments. In some embodiments, the graphical user interfaces 700 correspond to the cloud administration user interface 202 illustrated in FIGS. 2-6B. In some embodiments, the graphical user interfaces 700 enable the cloud administrator 112 to modify site-user information (e.g., site user identities, site user memberships, site user licensing, etc.) within a region (e.g., “Region A” illustrated in FIG. 3) and across regions (e.g., “Region A” and “Region B” illustrated in FIGS. 5 and 6), using features provided by the graphical user interfaces 700. In some embodiments, the cloud administrator 112 manages cloud sites through a cloud manager (e.g., cloud managers illustrated in FIGS. 1B-6B). In some embodiments, the graphical user interfaces 700 are part of the cloud manager.

FIG. 7A illustrates a first screenshot 701 of the example graphical user interfaces 700 displaying information related to cloud sites. The first screenshot 701 includes a menu pane 710 and a cloud site pane 720 displayed concurrently. The menu pane 710 includes three options, e.g., a “SITES” option 712, a “USERS” option 714, and a “SETTINGS” option 716. The first screenshot 701 corresponds to the “SITES” option 712 (e.g., a default option displayed when the cloud administrator 112 logs into the example graphical user interfaces 700). The cloud site pane 720 includes an information section 722 and a cloud site information table 728 (e.g., a table section). The information section 722 includes a cloud site count 724. For example, the cloud site count 724 indicates that the tenant associated with the cloud administrator 112 manages a total number of 100 cloud sites, with 28 cloud sites displayed in the first screenshot 701. The information section 722 further includes additional information about creators, explorers, and viewers. The information section 722 further includes a “NEW SITE” option 726 for adding new client site(s) to the tenant, either within the same region as the cloud manager 130 or in a different region. The cloud site information table 728 displays information about the cloud sites associated with the tenant (e.g., the 28 cloud sites referenced in the cloud site count 724). Specifically, the cloud site information table 728 includes a “NAME” column 730, a “USER” column 732, a “SITE ADMINISTRATORS” column 730, a “LOCATION” column 732. The “NAME” column 730 displays names of the cloud sites. The “USER” column 732 displays the number of site users added to each of the cloud sites. The “SITE ADMINISTRATORS” column 734 displays the number of site administrators added to each of the cloud sites. The “LOCATION” column 736 displays the name of a region where each of the cloud sites is deployed. For example, a first record 737 of the cloud site information table 728 shows that the cloud sites associated with the tenant include a cloud site named “01JULY,” which has one site user and one site administrators, deployed at the region “PROD_ONLINE EU.” In another example, a second record 738 of the cloud site information table 728 shows that the cloud sites associated with the tenant include a cloud site named “CANADA-VALIDATION,” which has 40 site users and 15 site administrators, deployed at the region “PROD_ONLINE_PR.”

FIG. 7B illustrates a second screenshot 702 of the example graphical user interfaces 700 displaying information related to site users. The second screenshot 702 includes the menu pane 710 and a site user pane 721 displayed concurrently. In particular, the second screenshot 702 corresponds to the “USERS” option 712 of the menu pane 710. In some embodiments, the second screenshot 702 is displayed in response to a user selection of the “USERS” option 714 (e.g., after the cloud administrator 112 selects (e.g., clicks) the “USERS” option 714). The site user pane 721 includes an information section 732 and a site-user information table 738 (e.g., a table section). The information section 732 includes a cloud site count 734. For example, the cloud site count 734 indicates that the cloud sites associated with the tenant and the cloud administrator 112 include a total number of 200 site users. The information section 732 further includes additional information about creators, explorers, viewers, and unlicensed site users. The information section 732 further includes an “ADD USERS” option 736 for adding new site user(s) to the cloud sites, either within the same region as the cloud manager 130 or in a different region. The site-user information table 738 displays information about the site users (e.g., the 200 site users referenced in the cloud site count 734) associated with the cloud sites. Specifically, the site-user information table 738 includes a “USERNAME” column 740 and a “SITES” column 742. The “USERNAME” column 740 displays the name of a site user (e.g., an email address) of a respective cloud site of the cloud sites. The “SITES” column 734 displays the number of cloud sites that a site user is assigned to. For example, a first record 743 of the site-user information table 738 shows that the cloud sites include a site user “0-B-CSVIMPORT-LINKUSER500@EXAMPLE.COM” and the site user is assigned to one cloud site. In another example, a second record 744 of the site-user information table 738 shows that the cloud sites include a site user “ASIMANTOV+123@TABLEAU.COM” and the site user is assigned to four cloud sites.

FIG. 7C illustrates a third screenshot 703 of the example graphical user interfaces 700, displaying information related to site users. The third screenshot 703 is displayed in response to a user selection of the “ADD USERS” option 736. Specifically, the third screenshot 703 includes an “ADD USERS” drop-down list 750 that is automatically displayed after the cloud administrator 112 selects (e.g., clicks) the “ADD USERS” option 736. The “ADD USERS” drop-down list 750 includes an “ADD USER BY EMAIL” option 752 and an “IMPORT USERS FROM FILE” option 754. The “ADD USER BY EMAIL” option 752 allows the user to add site user(s) using email address(es) (e.g., discussed below). The “IMPORT USERS FROM FILE” option 752 allows the cloud administrator 112 to add site user(s) by importing file(s) (e.g., CSV files, JSON files, text files, etc.).

FIG. 7D illustrates a fourth screenshot 704 of the example graphical user interfaces 700, displaying information related to site users. The fourth screenshot 704 is displayed in response to a user selection of the “ADD USER BY EMAIL” option 752. Specifically, the fourth screenshot 704 includes an “ADD USER” window 760 that is automatically displayed after the cloud administrator 112 selects (e.g., clicks) the “ADD USER BY EMAIL” option 752. The “ADD USER” window 760 is to receive a user request from the cloud administrator 112 to add a to-be-added site user to the site-user information. The “ADD USER” window 760 includes an input box 762 for entering email address(es) of a to-be-added site user, a “SEARCH” search bar 764 for typing target cloud site(s), a “SITE” drop-down list 766 for selecting the type of cloud sites to search for, and a list of cloud sites 768 displaying cloud sites that are available to the to-be-added site user. The list of cloud sites 768 includes a “SITE” column 770, a “SITE ROLE” column 772, and a SITE AUTHENTICATION″ column 774. In some circumstances, the list of cloud sites 768 is filtered based on inputs provided in the “SEARCH” search bar 764 and the “SITE” drop-down list 766. The cloud administrator 112 selects target cloud site(s) by checking corresponding checkbox(es) for the target cloud site(s). In some circumstances, the cloud administrator 112 selects corresponding site role(s) (e.g., administrator, viewer, explorer, etc.) in the “SITE ROLE” column 772 and site authentication(s) (e.g., multi-factor authentication (MFA), security assertion markup language (SAML), etc.) in the SITE AUTHENTICATION″ column 774. The cloud administrator 112 selects (e.g., clicks) an “ADD USER” option 778 of the “ADD USER” window 760 to add the to-be-added site user to the target cloud site(s). In some embodiments, the user request to add the to-be-added site user received from the “ADD USER” window 760 is used to update both the global database 134 of the cloud manager 130 and the local database 144 of the pod 140.

FIGS. 8A-8C illustrate another example graphical user interfaces 800 of a cloud management system (e.g., cloud management systems 100 and 200) for updating user information, in accordance with some embodiments. In some embodiments, the graphical user interfaces 800 correspond to the site administration user interface 204 illustrated in FIGS. 2-6B. In some embodiments, the graphical user interfaces 800 enable the site administrator 114 of a target site to modify site-user information (e.g., site user identities, site user memberships, site user licensing, etc.) of a respective cloud site of a respective pod (e.g., pod 140) within a region (e.g., “Region A” illustrated in FIG. 4), using features provided by the graphical user interfaces 800. In some embodiments, the site administrator 114 manages one or more cloud sites of a pod through a cloud manager (e.g., cloud managers illustrated in FIGS. 1B-6B). In some embodiments, the graphical user interfaces 800 are part of the pod.

FIG. 8A illustrates a first screenshot 801 of the example graphical user interfaces 800 displaying a main interface. The first screenshot 801 includes a menu pane 810 and a home pane 820 displayed concurrently. The menu pane 710 includes a plurality of options including a “Users” option 812. In some embodiments, the first screenshot 801 display a default view displayed when the site administrator 114 logs into the example graphical user interfaces 800.

FIG. 8B illustrates a second screenshot 802 of the example graphical user interfaces 800 displaying information related to site users. The second screenshot 802 includes the menu pane 810 and a site user pane 830 displayed concurrently. In particular, the second screenshot 802 corresponds to the “User” option 812 of the menu pane 810. In some embodiments, the second screenshot 802 is displayed in response to a user selection of the “User” option 812 (e.g., after the site administrator 114 selects (e.g., clicks) the “User” option 812). The site user pane 830 includes an information section 832 and a site-user information table 838 (e.g., a table section). The information section 832 includes a site user count 834. For example, the site user count 834 indicates that cloud sites associated with the respective pod include a total number of 60 site users. The information section 832 further includes additional information about creators, explorers, viewers, and unlicensed site users. The information section 732 further includes an “ADD USERS” option 836 for adding new site user(s) to the cloud sites within the same region as the respective pod. The site-user information table 838 displays information about the site users (e.g., the 60 site users referenced in the site user count 834) associated with the cloud sites. Specifically, the site-user information table 838 includes a “USERNAME” column 840, a “SITE ROLE” column 842, and a “AUTHENTICATION” column 844. The “USERNAME” column 740 displays the name of a site user (e.g., an email address) of a respective cloud site of the cloud sites. The “SITE ROLE” column 834 displays site role(s) that a site user is assigned to. The “AUTHENTICATION” column 844 displays an authentication method that a site user is assigned to. For example, a first record 845 of the site-user information table 838 shows that the cloud sites include a site user “0-B-CAVIMPORT-LINKUSER700@EXAMPLE.COM,” the site user is assigned to a site role of “site administrator” and a site role of “explorer,” and the site user is assigned to an authentication method of “TABLEAU.” In another example, a second record 846 of the site-user information table 838 shows that the cloud sites include a site user “ABROOKS+PECANSODA@SALESFORCE.COM,” the site user is assigned to a site role of “site administrator” and a site role of “creator,” and the site user is assigned to an authentication method of “TABLEAU WITH MFA.”

FIG. 8C illustrates a third screenshot 803 of the example graphical user interfaces 800, displaying information related to site users. Specifically, the third screenshot 803 includes an “ADD USER” window 850 that is automatically displayed after the site administrator 114 makes a selection through the “ADD USERS” option 836. The “ADD USERS” window 850 is to receive a user request from the site administrator 114 to add a to-be-added site user to the site-user information. The “ADD USERS” window 850 includes an “AUTHENTICATION” input box 852 for selecting an “authentication” method for to-be-added site user, a “ENTER USERNAMES” input box 854 search bar 764 for entering username(s) (e.g., email address(es)) of the to-be-added site user, and a “SITE ROLE” drop-down list 766 for selecting site role(s) for the to-be-added site user. The site administrator 114 selects (e.g., clicks) an “ADD USER” option 858 of the “ADD USERS” window 850 to add the to-be-added site user to the target site. In some embodiments, the user request to add the to-be-added site user received from the “ADD USERS” window 850 is used to update both the global database 134 of the cloud manager 130 and the local database 144 of the pod 140.

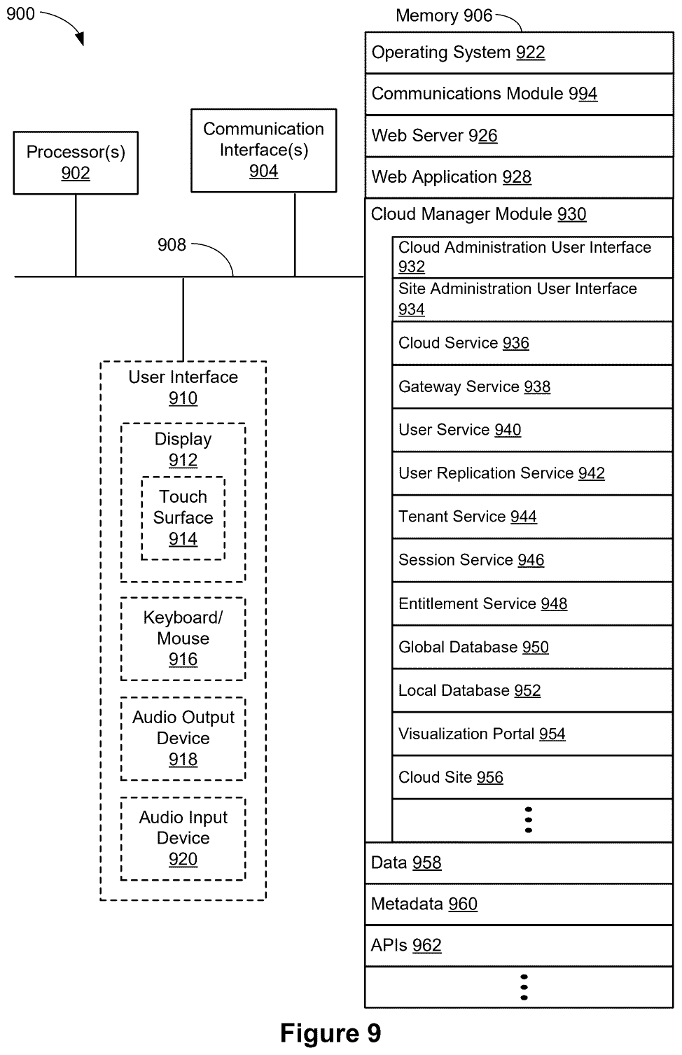

FIG. 9 is a block diagram illustrating a computing device 900, in accordance with some embodiments. In some embodiments, various examples of the computing device 900 include a desktop computer, a laptop computer, a tablet computer, and other computing devices that have a display and/or a processor capable of performing processes associated with a cloud management system (e.g., cloud management systems 100 and 200) and/or a cloud platform (e.g., cloud platform 150). The computing device 900 includes one or more processing units (processors or cores) 902, one or more network or other communication interfaces 904, memory 906, and one or more communication buses 908 for interconnecting these components. In some embodiments, the communication buses 908 include circuitry (sometimes called a chipset) that interconnects and controls communications between system components.

In some embodiments, the computing device 900 includes a user interface 910. In some embodiments, the user interface 910 includes a display device 912. Specifically, in some embodiments, the computing device 900 displays, via the display device 912, graphical user interface(s) associated with the cloud administration user interface 202 and the site administration user interface 204. Alternatively or in addition, in some embodiments, the display device 912 includes a touch-sensitive surface 914, in which case the display device 912 is a touch-sensitive display. In some embodiments, the touch-sensitive surface 914 is configured to detect various swipe gestures (e.g., continuous gestures in vertical and/or horizontal directions) and/or other gestures (e.g., single/double tap). In some circumstances, the computing device 900 that has a touch-sensitive display and/or a physical keyboard is optional (e.g., a soft keyboard may be displayed when keyboard entry is needed). In some embodiments, the computing device 900 includes input devices such as a keyboard, mouse, and/or other input buttons 916. In some embodiments, the user interface 910 includes an audio output device 918, such as speakers or an audio output connection connected to speakers, earphones, or headphones. In some embodiments, the user interface 910 includes an audio input device 920 (e.g., a microphone) to capture audio (e.g., speech from a user). In some circumstances, the audio input device 920 provides voice recognition to supplement or replace the keyboard.

In some embodiments, the memory 906 includes high-speed random-access memory, such as DRAM, SRAM, DDR RAM, or other random-access solid-state memory devices. In some embodiments, the memory 906 includes non-volatile memory, such as one or more magnetic disk storage devices, optical disk storage devices, flash memory devices, or other non-volatile solid-state storage devices. In some embodiments, the memory 906 includes one or more storage devices remotely located from the processors 902. The memory 906, or alternatively the non-volatile memory devices within the memory 906, includes a non-transitory computer-readable storage medium. In some embodiments, the memory 906, or the computer-readable storage medium of the memory 906, stores the following programs, modules, and data structures, or a subset or superset thereof:
an operating system 922, which includes procedures for handling various basic system services and for performing hardware dependent tasks;
a communications module 924, which is used for connecting the computing device 900 to other computers and devices via the one or more communication interfaces 904 (wired or wireless), such as the Internet, other wide area networks, local area networks, metropolitan area networks, and so on;
a web server 926 (such as an HTTP server), which receives web requests from users and responds by providing responsive web pages or other resources;
a web application 928, which may be downloaded and executed by the web server 926 on a user's computing device 900. In some embodiments, the web application 928 provides flexible access from any device at any location with network connectivity, and does not require installation and maintenance;
a cloud manager module 930 associated with a cloud management system (e.g., cloud management systems 100 and 200) and/or a cloud platform (e.g., cloud platform 150). In some embodiments, the cloud manager module 930 includes the following sub-modules (or sets of instructions), or a subset or superset thereof for managing cloud users and cloud sites:
   a cloud administration user interface sub-module 932 associated with a cloud administration user interface (e.g., cloud administration user interface 202 in FIG. 2);
   a site administration user interface sub-module 934 associated with a site administration user interface (e.g., site administration user interface 204 in FIG. 2);
   a cloud service sub-module 936 associated with cloud service (e.g., cloud services 302-A and 302-B in FIGS. 3A-6B);
   a gateway service sub-module 938 associated with gateway service (e.g., gateway service 201 in FIG. 2);
   a user service sub-module 940 associated with user service (e.g., user service 222 in FIG. 2);
   a user replication service sub-module 942 associated with user replication service (e.g., user replication services 232, 232-A, and 232-B in FIGS. 2-6B);
   a tenant service sub-module 944 associated with tenant service (e.g., tenant service 220 in FIG. 2);
   a session service sub-module 946 associated with session service (e.g., session service 216 in FIG. 2);
   an entitlement service sub-module 948 associated with entitlement service (e.g., entitlement service 218 in FIG. 2);
   a global database sub-module 950 associated with a global database (e.g., global databases 134, 234, 234-A, and 234-B in FIGS. 1B-6B). In some embodiments, the global database is included in a user storage (e.g., in reference to FIGS. 3A-6B);
   a local database sub-module 952 associated with local database (e.g., local databases 144, 244, and 244-B in FIGS. 1B-6B). In some embodiments, the local database includes a Postgre database;
   a visualization portal sub-module 954 associated with a visualization portal (e.g., visualization portal 142, 242, and 242-B in FIGS. 1B-6B); and
   a cloud site sub-module 956 associated with cloud sites of a respective pod (e.g., the plurality of cloud sites 210 and the pod 240 in FIG. 2);
Data 958;
Metadata 960; and
APIs 962, which may be called from one or more modules (e.g., the cloud manager module 930), and perform one or more actions.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 906 stores a subset of the modules and data structures identified above. Furthermore, the memory 906 may store additional modules or data structures not described above. In some embodiments, a subset of the programs, modules, and/or data stored in the memory 206 is stored on and/or executed by the computing device 900.

Although FIG. 9 illustrates a computing device 900, FIG. 9 is intended more as a functional description of the various features that may be present rather than as a structural schematic of the embodiments described herein. In practice, and as recognized by those of ordinary skill in the art, items shown separately could be combined and some items could be separated.

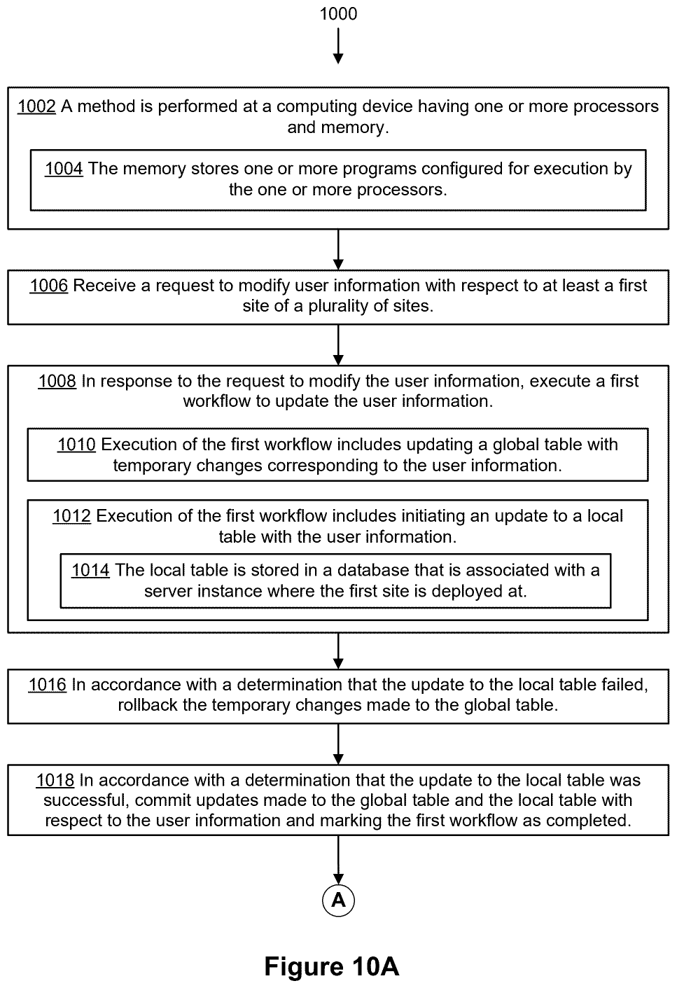

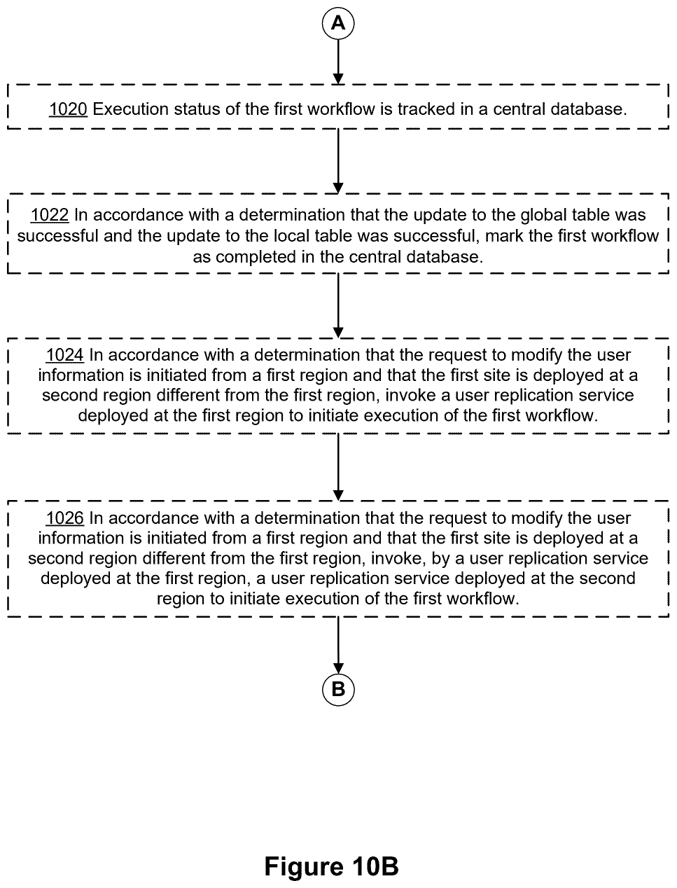

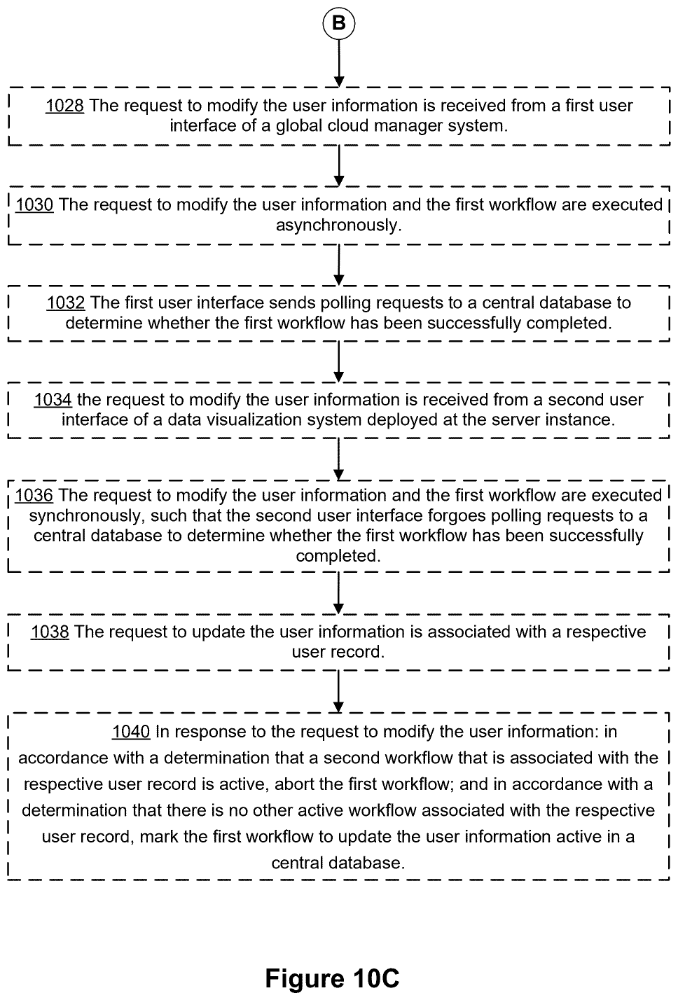

FIGS. 10A-10C illustrate a flow chart of an example method 1000 for managing user information, in accordance with some embodiments. In some embodiments, the method 1000 is called a process.

Referring to FIG. 10A, the method 1000 is performed (1002) at a computing device 900 that has one or more processors 902 and memory 906. The memory 906 stores (1004) one or more programs configured for execution by the one or more processors 902. In some embodiments, the operations or a subset of the operations shown in FIGS. 1-8C correspond to instructions stored in the memory 906 or other non-transitory computer-readable storage medium. The computer-readable storage medium may include a magnetic or optical disk storage device, solid state storage devices such as flash memory, or other non-volatile memory device or devices. In some embodiments, the instructions stored on the computer-readable storage medium include one or more of: source code, assembly language code, object code, or other instruction format that is interpreted by one or more processors. Some operations in the method 1000 may be combined and/or the order of some operations may be changed.

The computing device 900 receives (1006) a request (e.g., a user request such as a call from the cloud administrator 112 or the site administrator 114) to modify user information (e.g., user identities, user memberships, user licenses) with respect to at least a first site (e.g., cloud site 210-1 in FIG. 2) of a plurality of sites (e.g., the plurality of cloud sites 210 in FIG. 2). For example, in the step 321 shown in FIG. 3, the caller 320 (e.g., a cloud administrator) sends an in-region call as a user request to add a respective cloud user to a respective cloud site of the pod 240-A (e.g., adding a cloud user to a license for a corresponding target cloud site) via the cloud administration user interface 202. In another example, in the step 421 shown in FIG. 4, the caller 420 (e.g., a site administrator) sends an in-region call as a user request to add a respective cloud user to a respective cloud site of the pod 240-A (e.g., adding a cloud user to a license for a corresponding target cloud site) via the visualization portal 242-A.

In response to the request to modify the user information, the computing device 900 executes (1008) a first workflow to update user information. For example, as shown in FIG. 4, a flow of an in-region call (e.g., adding add a respective cloud user to a respective cloud site of the pod 240-A, where the cloud manager 230-A and the pod 240-A are deployed at the same “Region A”) to update user information includes the first set of operations 410 and the second set of operations 412. In particular, the second set of operations 412 are coordinated by the step functions 304-A. In another example, as shown in FIG. 5, a flow of a cross-region call (e.g., adding add a respective cloud user to a respective cloud site of the pod 240-B, where the cloud manager 230-A and the pod 240-B are deployed at the “Region A” and “Region B,” respectively) to update user information includes the first set of operations 510 and the second set of operations 512. Similarly, the second set of operations 512 are coordinated by the step functions 304-A.

Execution of the first workflow to update the user information includes updating (1010) a global table with temporary changes corresponding to the user information. In some embodiments, the global table is included in a global database (e.g., global database 234 in FIG. 2). In some embodiments, the global database (e.g., global database 234-A) is included in a user storage (e.g., user storage 310-A in FIGS. 3A-5B). For example, in the step 431 shown in FIG. 4, in response to receiving a request to add a respective cloud user, the user service 222-A sends a request to modify site-user information stored in the global database 234-A. In another example, in the step 535 shown in FIG. 5, in response to receiving the request to add the respective cloud user, the user service 222-A sends a request to modify site-user information stored in the global database 234-A. Specifically, in both steps 431 and 535, modifying the site-user information is to make temporary changes to the global table.

Execution of the first workflow to update the user information includes initiating (1012) an update to a local table with the user information. The local table is stored in a database that is associated with a server instance where the first site is deployed at. For example, in the step 538 shown in FIG. 5, in response to receiving an OK status, the step functions 304 sends a request to the user replication service 232-A, which is deployed at “Region A,” for adding a respective cloud user to a corresponding target cloud site of the pod 240-B, which is deployed at “Region B.” Moreover, in the step 541 shown in FIG. 5, in response to receiving a request for adding a respective cloud user, the visualization portal 242-B executes an operation to insert the respective cloud user to the local database 244-B associated with the corresponding target cloud site. In some embodiments, the local table is included in the local database (e.g., local databases 244 and 244-B in FIGS. 2-6B). In some embodiments, a pod includes a server instance within infrastructure of a cloud manager system. For example, in some embodiments, each pod of plurality of pods 140-1 to 140-m in FIG. 1B represent a server instance running on hardware infrastructure located at different regions 122-1 to 122-m, respectively. In some embodiments, the local database of a pod includes a Postgre database.

In accordance with a determination that the update to the local table failed, the computing device 900 rollbacks (1014) the temporary changes made to the global table. For example, as shown in FIG. 4, the first subset operations 414-1 of the third set of operations 414 corresponds to a rollback process when adding a respective cloud user to a respective target cloud site of the pod 140 failed (e.g., a call from the caller 420 (e.g., a site administrator) to the pod 140 failed). In another example, as shown in FIG. 5, in accordance with a determination that a call from the caller 520 (e.g., a cloud administrator) to the pod 140 failed, the first subset operations 514-1 are subsequently performed to rollback.

In accordance with a determination that the update to the local table was successful, the computing device 900 commits (1016) updates made to the global table and the local table with respect to the user information and marking the first workflow as completed. For example, in step 444 shown in FIG. 4, in accordance with a determination that the call from the cloud manager 230-A (e.g., in “Region A”) to the pod 240-A (e.g., in “Region A”) was successful (e.g., in an event of a success), the step functions 304-A send an information indicative to the user service 222-A indicating that the call is committed. In another example, in step 549 shown in FIG. 5, in accordance with a determination that the call from the cloud manager 230-A (e.g., in “Region A”) to the pod 240-B (e.g., in “Region B”) was successful (e.g., in an event of a success), the step functions 304-A send an information indicative to the user service 222-A indicating that the call is committed.

In some embodiments, execution status of the first workflow is tracked (1020) in a central database (e.g., the workflow database 306-A included in the cloud service 302-A in FIGS. 3A-5B). In some embodiments, a cloud service orchestrates a series of operations in a cloud manager system (e.g., cloud manager systems 100 and 200). For example, in the event of a failure, the cloud service 302-A executes, via the steps function 304-A, rollback operations to ensure consistency and integrity (e.g., illustrated in FIGS. 3A-5B).

In some embodiments, in accordance with a determination that the update to the global table was successful and the update to the local table was successful, the computing device 900 marks (1022) the first workflow as completed in the central database. For example, in step 445 shown in FIG. 4, in response to receiving an information indicative from the step functions 304, the user service 222 sends an OK status to the step functions 304-A, such that the workflow database 306 marks a cross-region cloud user information update as completed. In another example, in step 550 shown in FIG. 5, in response to receiving the information indicative from the step functions 304-A, the user service 222-A sends an OK status to the step functions 550-A.

In some embodiments, in accordance with a determination that the request to modify the user information is initiated from a first region and that the first site is deployed at a second region different from the first region, the computing device 900 invokes (1024) a user replication service deployed at the first region to initiate execution of the first workflow. For example, in steps 524-526 as shown in FIG. 5, in response to receiving a request for obtaining site information (e.g., a respective cloud site of the pod 140), the tenant service 220-A sends the site information (e.g., the respective cloud site is deployed at “Region B”) to the user service 222-A. In response to receiving the site information, the user service 222-A initiates a user replication request to the user replication service 232-A (e.g., deployed at “Region A”) for replicating a cross-region cloud user information update, which is initiated from the cloud manager 230-A deployed at “Region A.” In response to receiving the user replication request, the user replication service 232-A sends a request to the steps function 304-A for starting a replication workflow.

In some embodiments, in accordance with a determination that the request to modify the user information is initiated from a first region and that the first site is deployed at a second region different from the first region, the computing device 900 invokes (1026), by a user replication service deployed at the first region, a user replication service deployed at the second region to initiate execution of the first workflow. For example, in steps 624-626 as shown in FIG. 6, in response to receiving a user replication request, the user replication service 232-A (e.g., deployed at “Region A”) sends a request to the tenant service 220-A (e.g., deployed at “Region A”) for getting region information (e.g., a respective target cloud site is deployed at “Region B”) about a corresponding target cloud site. In response to receiving the request, the tenant service 220-A (e.g., deployed at “Region A”) sends the region information (e.g., “Region B”) to the user replication service 232-A (e.g., deployed at “Region A”) for replicating a cross-region cloud user information update. In response to receiving the region information, the user replication service 232-A (e.g., deployed at “Region A”) sends a request to the user replication service 232-B (e.g., deployed at “Region B”) for starting a replication workflow.

In some embodiments, the request to modify the user information is received (1028) from a first user interface of a global cloud manager system. For example, as shown in FIGS. 7A-7D, the graphical user interfaces 700 enable the cloud administrator 112 to modify site-user information (e.g., site user identities, site user memberships, site user licensing, etc.) within a region (e.g., “Region A” illustrated in FIG. 3) and across regions (e.g., “Region A” and “Region B” illustrated in FIGS. 5 and 6), using features provided by the graphical user interfaces 700. In some embodiments, the graphical user interfaces 700 are similar to the cloud administration user interface 202.

In some embodiments, the request to modify the user information and the first workflow are executed (1030) asynchronously. For example, as shown in FIG. 4, the first set of operations 410, the bundle of the second and third sets of operations 412 and 414, and the fourth set of operations 416 for an in-region cloud user information update are asynchronous. In another example, as shown in FIG. 6, the first set of operations 610, the bundle of the second and third sets of operations 612 and 614, and the fourth set of operations 616 for a cross-region cloud user information update are asynchronous. In some embodiments, the asynchronization is to avoid time-out when a cloud user update consumes excessive amount of time.

In some embodiments, the first user interface sends (1032) polling requests to the central database to determine whether the first workflow has been successfully completed. For example, as shown in FIG. 5, the fourth set of operations 516 initializes polling requests to the workflow database 306-A (e.g., central database of the cloud service 302-A) for a status associated with the pending cross-region cloud user information update. The fourth set of operations 516 repeats until the user request for the cross-region cloud user information update is successful. In some embodiments, when the fourth set of operations 516 is executed, the cloud administration user interface 202-A displays to the caller 320 an indication (e.g., a spinning bar) showing a pending status.

In some embodiments, the request to modify the user information is received (1034) from a second user interface of a data visualization system deployed at the server instance. For example, as shown in FIGS. 8A-8C, the graphical user interfaces 800 enable the site administrator 114 of a target cloud site to modify site-user information (e.g., site user identities, site user memberships, site user licensing, etc.) of a respective target cloud site of a respective pod (e.g., pod 140) within a region (e.g., “Region A” illustrated in FIG. 4), using features provided by the graphical user interfaces 800. In some embodiments, the graphical user interfaces 800 are similar to the site administration user interface 204.

In some embodiments, the request to modify the user information and the first workflow are executed (1036) synchronously, such that the second user interface forgoes polling requests to a central database to determine whether the first workflow has been successfully completed. For example, as shown in FIG. 4, the operations associated with the first to fourth sets of operations 410 to 416 for an in-region cloud user information update are synchronous from a perspective of the caller 420 (e.g., represented by a vertical bar 401). Specifically, the visualization portal 242-A polls a status of a replication workflow (e.g., the fourth set of operations 416) before a response is sent back to the caller 420 (e.g., in a synchronous manner).

In some embodiments, the request to update the user information is associated (1038) with a respective user record. For example, as shown in FIGS. 7A-7D, the cloud administrator 112 can add a respective cloud user to a target cloud site through the “ADD USER” window 760 of the example graphical user interfaces 700. In particular, the cloud administrator 112 can enter an email address of a to-be-added site user and select target cloud site(s) from the list of cloud sites 768 by checking corresponding checkbox(es) 776. In another example, as shown in FIGS. 8A-8C, the site administrator 114 can add a respective cloud user to a target cloud site through the “ADD USER” window 850 of the graphical user interfaces 800. In particular, the site administrator 114 can enter a username of a to-be-added site user in the “ENTER USERNAMES” input box 854 and select a site role e.g., administrator, viewer, explorer, etc.) for the to-be-added site user.

In some embodiments, in response to the request to modify the user information: in accordance with a determination that a second workflow that is associated with the respective user record is active, the computing device 900 aborts (1040) the first workflow; and in accordance with a determination that there is no other active workflow associated with the respective user record, the computing device 900 marks the first workflow to update the user information active in a central database. For example, the step functions of a cloud service actively monitors workflow(s). While a replication workflow of replicating user data for updating a user information associated with a respective user record is currently active, in accordance with a determination that another workflow of replicating user data that is associated with the respective user record is also active, the cloud manager aborts the workflow via the step functions of the cloud service. Accordingly, a workflow database of the cloud service is updated to reflect the abortion of the workflow. Similarly, in accordance with a determination that no other workflow of replicating user data is active, the cloud manager initiates an update to the workflow database of the cloud service for indicating that the current workflow of replicating user data is the only active workflow.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
at a computing device having one or more processors and memory storing one or more programs configured for execution by the one or more processors:
receiving a request to modify user information with respect to at least a first site of a plurality of sites;
in response to the request to modify the user information, executing a first workflow to update the user information, including:
updating a global table with temporary changes corresponding to the user information; and
initiating an update to a local table with the user information, wherein the local table is stored in a database that is associated with a server instance where the first site is deployed at;
in accordance with a determination that the update to the local table failed, rollbacking the temporary changes made to the global table; and
in accordance with a determination that the update to the local table was successful, committing updates made to the global table and the local table with respect to the user information and marking the first workflow as completed.

2. The method of claim 1, wherein execution status of the first workflow is tracked in a central database, and the method includes:
in accordance with a determination that the update to the global table was successful and the update to the local table was successful, marking the first workflow as completed in the central database.

3. The method of claim 1, comprising:
in accordance with a determination that the request to modify the user information is initiated from a first region and that the first site is deployed at a second region different from the first region, invoking a user replication service deployed at the first region to initiate execution of the first workflow.

4. The method of claim 1, comprising:
in accordance with a determination that the request to modify the user information is initiated from a first region and that the first site is deployed at a second region different from the first region, invoking, by a user replication service deployed at the first region, a user replication service deployed at the second region to initiate execution of the first workflow.

5. The method of claim 1, wherein:
the request to modify the user information is received from a first user interface of a global cloud manager system;
the request to modify the user information and the first workflow are executed asynchronously; and
the first user interface sends polling requests to a central database to determine whether the first workflow has been successfully completed.

6. The method of claim 1, wherein:
the request to modify the user information is received from a second user interface of a data visualization system deployed at the server instance; and
the request to modify the user information and the first workflow are executed synchronously, such that the second user interface forgoes polling requests to a central database to determine whether the first workflow has been successfully completed.

7. The method of claim 1, wherein the request to update the user information is associated with a respective user record, and the method includes:
in response to the request to modify the user information:
in accordance with a determination that a second workflow that is associated with the respective user record is active, aborting the first workflow;
in accordance with a determination that there is no other active workflow associated with the respective user record, marking the first workflow to update the user information active in a central database.

8. A computing device, comprising:
one or more processors; and
memory coupled to the one or more processors, the memory storing one or more programs configured to be executed by the one or more processors, the one or more programs including instructions for:
receiving a request to modify user information with respect to at least a first site of a plurality of sites;
in response to the request to modify the user information, executing a first workflow to update the user information, including:
updating a global table with temporary changes corresponding to the user information; and
initiating an update to a local table with the user information, wherein the local table is stored in a database that is associated with a server instance where the first site is deployed at;
in accordance with a determination that the update to the local table failed, rollbacking the temporary changes made to the global table; and
in accordance with a determination that the update to the local table was successful, committing updates made to the global table and the local table with respect to the user information and marking the first workflow as completed.

9. The computing device of claim 8, wherein execution status of the first workflow is tracked in a central database, and the one or more programs include instructions for:
in accordance with a determination that the update to the global table was successful and the update to the local table was successful, marking the first workflow as completed in the central database.

10. The computing device of claim 8, wherein the one or more programs include instructions for:
in accordance with a determination that the request to modify the user information is initiated from a first region and that the first site is deployed at a second region different from the first region, invoking a user replication service deployed at the first region to initiate execution of the first workflow.

11. The computing device of claim 8, wherein the one or more programs include instructions for:
in accordance with a determination that the request to modify the user information is initiated from a first region and that the first site is deployed at a second region different from the first region, invoking, by a user replication service deployed at the first region, a user replication service deployed at the second region to initiate execution of the first workflow.

12. The computing device of claim 8, wherein:
the request to modify the user information is received from a first user interface of a global cloud manager system;
the request to modify the user information and the first workflow are executed asynchronously; and
the first user interface sends polling requests to a central database to determine whether the first workflow has been successfully completed.

13. The computing device of claim 8, wherein:
the request to modify the user information is received from a second user interface of a data visualization system deployed at the server instance; and
the request to modify the user information and the first workflow are executed synchronously, such that the second user interface forgoes polling requests to a central database to determine whether the first workflow has been successfully completed.

14. The computing device of claim 8, wherein the request to update the user information is associated with a respective user record, and the one or more programs include instructions for:
in response to the request to modify the user information:
in accordance with a determination that a second workflow that is associated with the respective user record is active, aborting the first workflow;
in accordance with a determination that there is no other active workflow associated with the respective user record, marking the first workflow to update the user information active in a central database.

15. A non-transitory computer-readable storage medium storing one or more programs, the one or more programs comprising instructions, which when executed by a computing device, cause the computing device to perform operations comprising:
receiving a request to modify user information with respect to at least a first site of a plurality of sites;
in response to the request to modify the user information, executing a first workflow to update the user information, including:
updating a global table with temporary changes corresponding to the user information; and
initiating an update to a local table with the user information, wherein the local table is stored in a database that is associated with a server instance where the first site is deployed at;
in accordance with a determination that the update to the local table failed, rollbacking the temporary changes made to the global table; and
in accordance with a determination that the update to the local table was successful, committing updates made to the global table and the local table with respect to the user information and marking the first workflow as completed.

16. The non-transitory computer-readable storage medium of claim 15, wherein execution status of the first workflow is tracked in a central database, and the one or more programs include instructions that, which when executed by the computing device, cause the computing device to perform operations including:
in accordance with a determination that the update to the global table was successful and the update to the local table was successful, marking the first workflow as completed in the central database.

17. The non-transitory computer-readable storage medium of claim 15, wherein the one or more programs include instructions that, which when executed by the computing device, cause the computing device to perform operations including:
in accordance with a determination that the request to modify the user information is initiated from a first region and that the first site is deployed at a second region different from the first region, invoking a user replication service deployed at the first region to initiate execution of the first workflow.

18. The non-transitory computer-readable storage medium of claim 15, wherein the one or more programs include instructions that, which when executed by the computing device, cause the computing device to perform operations including:
in accordance with a determination that the request to modify the user information is initiated from a first region and that the first site is deployed at a second region different from the first region, invoking, by a user replication service deployed at the first region, a user replication service deployed at the second region to initiate execution of the first workflow.

19. The non-transitory computer-readable storage medium of claim 15, wherein:
the request to modify the user information is received from a first user interface of a global cloud manager system;
the request to modify the user information and the first workflow are executed asynchronously; and
the first user interface sends polling requests to a central database to determine whether the first workflow has been successfully completed.

20. The non-transitory computer-readable storage medium of claim 15, wherein:
the request to modify the user information is received from a second user interface of a data visualization system deployed at the server instance; and
the request to modify the user information and the first workflow are executed synchronously, such that the second user interface forgoes polling requests to a central database to determine whether the first workflow has been successfully completed.
